(19) United States
(12) Patent Application Publication
(10) Pub. No.: US 2019/0116185 A1
(43) Pub. Date: Apr. 18, 2019

(54) ACCESS AUTHORITY MANAGEMENT METHOD, ACCESS AUTHORITY MANAGEMENT SYSTEM, AND ACCESS AUTHORITY MANAGEMENT APPARATUS

(71) Applicant: HITACHI, LTD., Tokyo (JP)

(72) Inventors: Takayuki NAGAI, Tokyo (JP); Hironori EMARU, Tokyo (JP)

(73) Assignee: HITACHI, LTD., Tokyo (JP)

(21) Appl. No.: 16/129,681

(22) Filed: Sep. 12, 2018

(30) Foreign Application Priority Data
Oct. 16, 2017 (JP) 2017-200326

(51) Int. Cl. H04L 29/06; H04L 9/32; H04L 29/08; G06F 17/30

(52) U.S. Cl. CPC H04L 63/10; H04L 9/3236; H04L 67/1093; H04L 2209/38; G06F 17/30194; H04L 2209/56; H04L 67/24

(57) ABSTRACT

In an access authority management system constituting a business network by predetermined business entities, a predetermined node is configured to execute a predetermined smart contract in accordance with contents of a transaction issued along with execution of a predetermined process and stored in a distributed ledger; and execute a predetermined process related to authority management of data access in a distributed ledger by a predetermined node of a participant in the business network based on an execution result of the smart contract.

### CROSS-REFERENCE TO RELATED APPLICATION

This application claims priority pursuant to 35 U.S.C. § 119 from Japanese Patent Application No. 2017-200326, filed on Oct. 16, 2017, the entire disclosure of which is incorporated herein by reference.

### BACKGROUND

The present invention relates to an access authority management method, an access authority management system, and an access authority management apparatus. Specifically, the present invention relates to a technology for enabling appropriate management of authority of data access in a distributed ledger, by a participant in a consortium distributed ledger infrastructure.

Conventionally, as a technology for replacing transactions that have been implemented via reliable centralized authorities such as financial institutions and governments with direct transactions by peer-to-peer (P2P) between users, a distributed ledger technology using a blockchain (hereinafter also referred to as BC) has appeared.

Main features of a current distributed ledger technology includes: (1) establishing transactions among participants in the distributed ledger system by consensus formation and approval by (optional or specific) participants rather than centralized authorities; (2) collecting a plurality of transactions as a block, recording them to be connected in a row in a distributed ledger called a blockchain, and applying a hash calculation to consecutive blocks to substantially disable falsification; and (3) allowing all participants to share the same ledger data so that transactions can be confirmed by all the participants.

From the features described above, applications of such a distributed ledger technology using a BC have been considered in a wide range of fields such as finance and manufacturing industries, as a mechanism for reliably managing and sharing data and executing and managing transactions based on a contract.

As one of such applications, in order to make the distributed ledger technology applicable to complex transaction conditions and various applications, there have also been proposed technologies that can manage not only transaction data but also logic describing transaction conditions, that is, a smart contract (hereinafter also referred to as SC) in the distributed ledger.

In addition, a “consortium” distributed ledger infrastructure has also been proposed, in which only computers authorized by a specific single or multiple groups or persons, such as consortiums in specific industries or multiple companies related to a supply chain, become approvers of transactions. In such a consortium distributed ledger infrastructure, there is an advantage that a speed of transaction approval can be speeded up since there is a management entity that selects approvers.

As a conventional technology related to the above SC, a technology related to a distributed ledger infrastructure having an execution function of the SC (see “Ethereum White Paper”, Internet <URL: https://github.com/ethereum/wiki/wiki/White-Paper> online, searched on Jun. 30, 2017 and “Hyperledger Fabric”, Internet <URL: http://hyperledger-fabric.readthedocs.io/en/latest/> online, searched on Jun. 30, 2017) has been proposed. In such a distributed ledger infrastructure, information (ledger) will be shared on multiple nodes by accepting a transaction (hereinafter also referred to as TX) while forming consensus at a predetermined consensus standard between nodes, executing a TX at each node, and holding an execution result of the TX. Further, an SC execution function for executing a predetermined logic for the above TX is provided.

As an application example of the distributed ledger technology using the BC in the manufacturing industry, particularly in a supply chain management field, there has been proposed a technology (see U.S. Pat. No. 9,436,923) for enabling tracing of a merchandise flow between business entities by encrypting and recording trading records between business entities in a distributed ledger infrastructure in which a plurality of business entities participates, and by joining the records as necessary.

### SUMMARY

However, when applying the above consortium distributed ledger infrastructure to traceability management in a supply chain, there are cases where data sharing among participants via distributed ledger, which is a feature of distributed ledger technology, may rather cause problems.

For example, depending on positions or business practices of buyers and suppliers that make up the supply chain, a situation in which data managed by each participant is not disclosed to other participants is also common. However, if the distributed ledger technology is applied as it is to the traceability management in such a supply chain, the data is to be shared with other parties to whom the data is not originally disclosed.

Specifically, for example, from the viewpoint of a buyer, it is naturally required to be able to refer to each piece of data of a product manufactured by the buyer and components purchased from each supplier for use in the product. However, disclosing a business relationship with each supplier and transaction details to other companies is undesirable in terms of business. This may be similarly applicable to each participant in the supply chain regardless of buyer or supplier.

Accordingly, it is an object of the present invention to provide a technology for enabling appropriate management of authority of data access in a distributed ledger, by a participant in a consortium distributed ledger infrastructure.

An access authority management method of the present invention for solving the above includes: in a distributed ledger system constituting a business network by predetermined business entities, executing, by at least one predetermined node, a predetermined smart contract in accordance with contents of a transaction issued along with execution of a predetermined process and stored in a distributed ledger; executing, based on an execution result of the smart contract, a predetermined process related to authority management of data access in a distributed ledger by a predetermined node of a participant in the business network.

Further, an access authority management system of the present invention is a distributed ledger system constituting a business network by predetermined business entities. The access authority management system includes a plurality of information processing apparatuses each including: a storage device configured to store at least a distributed ledger that stores a transaction issued along with execution of a predetermined process; and a computing device configured to execute a predetermined smart contract in accordance with contents of a transaction stored in the distributed ledger, and execute, based on an execution result of the smart contract, a predetermined process related to authority management of data access in a distributed ledger by a predetermined node of a participant in the business network.

Furthermore, an access authority management apparatus of the present invention is at least one predetermined node in a distributed ledger system constituting a business network by predetermined business entities. The access authority management apparatus includes: a storage device configured to store at least a distributed ledger that stores a transaction issued along with execution of a predetermined process; and a computing device configured to execute a predetermined smart contract in accordance with contents of a transaction stored in the distributed ledger, and execute, based on an execution result of the smart contract, a predetermined process related to authority management of data access in a distributed ledger by a predetermined node of a participant in the business network.

According to the present invention, it is possible to enable appropriate management of authority of data access in a distributed ledger, by a participant in a consortium distributed ledger infrastructure.

### BRIEF DESCRIPTION OF THE DRAWINGS

FIG. 1A is a diagram showing a configuration example of an access authority management system in a first embodiment;

FIG. 1B is a diagram showing a hardware configuration example of an information processing apparatus in the first embodiment;

FIG. 2A is a view showing a first configuration example of a transaction history management table in the first embodiment;

FIG. 2B is a view showing a second configuration example of the transaction history management table in the first embodiment;

FIG. 3A is a view showing a first configuration example of a manufacturing history management table in the first embodiment;

FIG. 3B is a view showing a second configuration example of the manufacturing history management table in the first embodiment;

FIG. 4 is a diagram showing a configuration example of a blockchain in the first embodiment;

FIG. 5 is a view showing a configuration example of state information in the first embodiment;

FIG. 6 is a view showing a configuration example of a member management table the first embodiment;

FIG. 7 is a view showing a configuration example of an access authority management table in the first embodiment;

FIG. 8 is a flowchart showing a first flow example of an access authority management method in the first embodiment;

FIG. 9 is a flowchart showing a second flow example of the access authority management method in the first embodiment;

FIG. 10A is a flowchart showing a third flow example of the access authority management method in the first embodiment;

FIG. 10B is a flowchart showing a fourth flow example of the access authority management method in the first embodiment;

FIG. 11A is a flowchart showing a fifth flow example of the access authority management method in the first embodiment;

FIG. 11B is a flowchart showing a sixth flow example of the access authority management method in the first embodiment;

FIG. 12 is a view showing an example of a screen in the first embodiment;

FIG. 13A is a conceptual diagram showing an example of a writing process in the access authority management table of the first embodiment;

FIG. 13B is a conceptual diagram showing an example of a writing process in a distributed ledger and the access authority management table of the first embodiment;

FIG. 14 is a diagram showing a configuration example of a computer system in a second embodiment;

FIG. 15A is a diagram showing a first configuration example of a blockchain in the second embodiment;

FIG. 15B is a diagram showing a second configuration example of the blockchain in the second embodiment;

FIG. 16 is a view showing a configuration example of state information in the second embodiment;

FIG. 17A is a flowchart showing a first flow example of an access authority management method in the second embodiment;

FIG. 17B is a flowchart showing a second flow example of the access authority management method in the second embodiment;

FIG. 18A is a flowchart showing a third flow example of the access authority management method in the second embodiment;

FIG. 18B is a flowchart showing a fourth flow example of the access authority management method in the second embodiment;

FIG. 19 is a flowchart showing a fifth flow example of the access authority management method in the second embodiment; and

FIG. 20 is a flowchart showing a sixth flow example of the access authority management method in the second embodiment.

### DESCRIPTION OF THE EMBODIMENTS

### First Embodiment

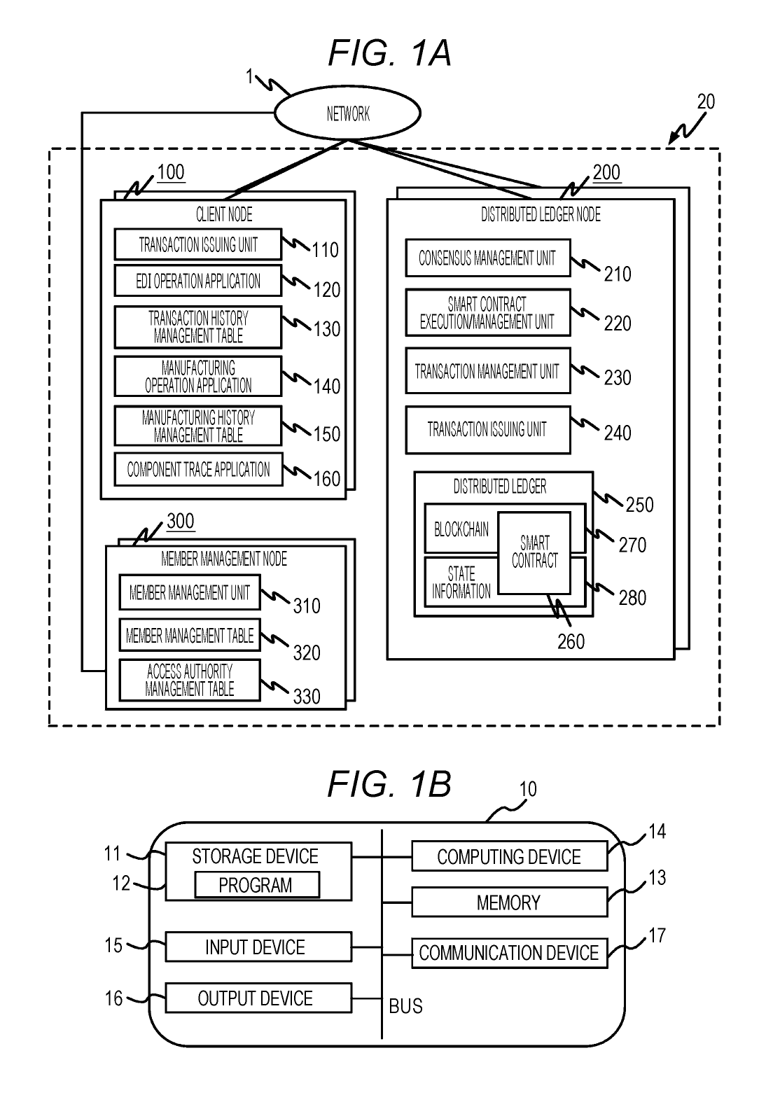

FIG. 1A is a diagram showing a configuration example of an access authority management system in a first embodiment. Here, as an example, description will proceed in assuming a situation where an access authority management technique is applied to a business network constituting a supply chain accompanying product manufacture, and access authority management of various data occurring in the supply chain is managed.

An access authority management system 20 exemplified in FIG. 1A is a distributed ledger system, and is configured by one or more client nodes 100, one or more distributed ledger nodes 200, and one or more member management nodes 300. These devices are connected to a network 1 via a physical communication line and are capable of communicating with each other.

In this embodiment, there is a plurality of distributed ledger nodes 200. Further, it is assumed that each of the distributed ledger nodes 200 is operated and managed by each of entities (e.g., multiple business entities, multiple organizations, and multiple vendors) constituting a consortium.

Similarly, there is also a plurality of client nodes 100. Further, it is assumed that each of the client nodes 100 is used by each SC user who is a participant of the business network.

Further, it can be assumed that there is also a plurality of member management nodes 300. Such a plurality of member management nodes 300 coexists while each of them shares the same information, so that redundancy for coping with a failure or the like can be secured. Alternatively, a configuration may be adopted in which a plurality of subgroups is provided under the consortium and a different member management node 300 is selectively used for each subgroup. When there is a plurality of member management nodes 300, each of the distributed ledger nodes 200 holds information on which member management node 300 is to be accessed, as setting information in advance.

As exemplified in FIG. 1B, a physical entity of the client node 100, the distributed ledger node 200, and the member management node 300 is a general computer including: a storage device 11 including a non-volatile storage element such as an SSD; a memory 13 including a volatile memory element such as a RAM; a computing device 14 such as a CPU configured to perform integrated control of the device itself by reading out a program 12 stored in the storage device 11 into the memory 13, and to perform various determination, calculation, and control processing;

an input device 15 configured to receive key input and voice input from a user; an output device 16 such as a display configured to display processing data; and a communication device 17 connected to the network 1 and responsible for communication processing with other devices.

Among the devices constituting the access authority management system 20 described above, the client node 100 is configured by a transaction issuing unit 110, an electronic data interchange (EDI) operation application 120, a transaction history management table 130, a manufacturing operation application 140, a manufacturing history management table 150, and a component trace application 160.

Among them, the EDI operation application 120 and the manufacturing operation application 140 are applications to receive information on shipment, arrival, or manufacturing of a component from a user, and accumulate a history including the information in each of the transaction history management table 130 and the manufacturing history management table 150.

Further, upon receiving the information on shipment, arrival, or manufacturing of the component described above, the EDI operation application 120 and the manufacturing operation application 140 issue a TX including the information via the transaction issuing unit 110, and transmit a history of the transaction or manufacturing of the component to the distributed ledger node 200.

In a case of a TX associated with shipment of the component, the entity of the issuer of the above TX is a shipper described in a field 1303 of the transaction history management table 130 to be described later.

Whereas, in a case of a TX associated with arrival of the component, the entity of the issuer of this TX is a receiver described in a field 1306 of the transaction history management table 130 to be described later. In a case of a TX associated with manufacturing of the component, the entity of the issuer of this TX is a manufacturer described in a field 1501 of the manufacturing history management table 150 to be described later. A TX is assigned with issuer information. This issuer information includes a member ID previously assigned by the member management node 300 in a form associated with the shipper, the receiver, or the manufacturer described above, and authentication information (a secret key) issued for each member by the member management node 300.

Further, the component trace application 160 is an application that issues, via the transaction issuing unit 110, a TX for acquiring information on a history of the transaction and manufacturing of a component used for manufacturing a predetermined product, and displays component trace information obtained from that to the user.

It should be noted that the client node 100 may exclusively include either one of the EDI operation application 120 or the manufacturing operation application 140.

Among the devices constituting the access authority management system 20 described above, the distributed ledger node 200 is configured by a consensus management unit 210, a smart contract execution/management unit 220 (hereinafter also referred to as SC execution/management unit), a transaction management unit 230, a transaction issuing unit 240, and a distributed ledger 250.

This distributed ledger node 200 receives the TX via the network 1 by a function of the transaction management unit 230, forms consensus on whether to accept the TX between with other nodes by a function of the consensus management unit 210, performs deployment of the SC and execution for the deployed SC through a function of the SC execution/management unit 220 when the consensus is formed, and records a history of the TX and an execution result thereof in the distributed ledger 250.

In addition, the transaction management unit 230 of the distributed ledger node 200 provides a function/interface to accept a TX and to acquire and browse history information of the TX in response to a request from each node such as the client node 100. In this embodiment, the distributed ledger node 200 is also capable of issuing a TX, and various types of the TX are issued via the transaction issuing unit 240.

The distributed ledger 250 stores and manages a smart contract 260 related to various operations such as shipment, arrival, and manufacturing, and an execution result of the SC. As the data structure, for example, it is assumed that a history of a TX is set as a blockchain 270, and state information 280 based on an execution result of a TX is held in a table format.

Among the devices constituting the access authority management system 20 described above, the member management node 300 is configured by a member management unit 310, a member management table 320, and an access authority management table 330.

Among them, the member management unit 310 provides new issue and authentication functions of members such as buyers and suppliers who participate in the consortium. In the member management unit 310, it is assumed that authentication of a participating member, signature to a TX, control of SC execution authority, and the like are performed using a pair of a secret key and a public key. Such key information such as on the secret key and the public key related to member management is stored and managed in the member management table 320. Whereas, when receiving the TX, the transaction management unit 230 in the distributed ledger node 200 described above is to check whether or not the issuer of the TX is a proper participant with authority, through a function of the member management unit 310 in the member management node 300.

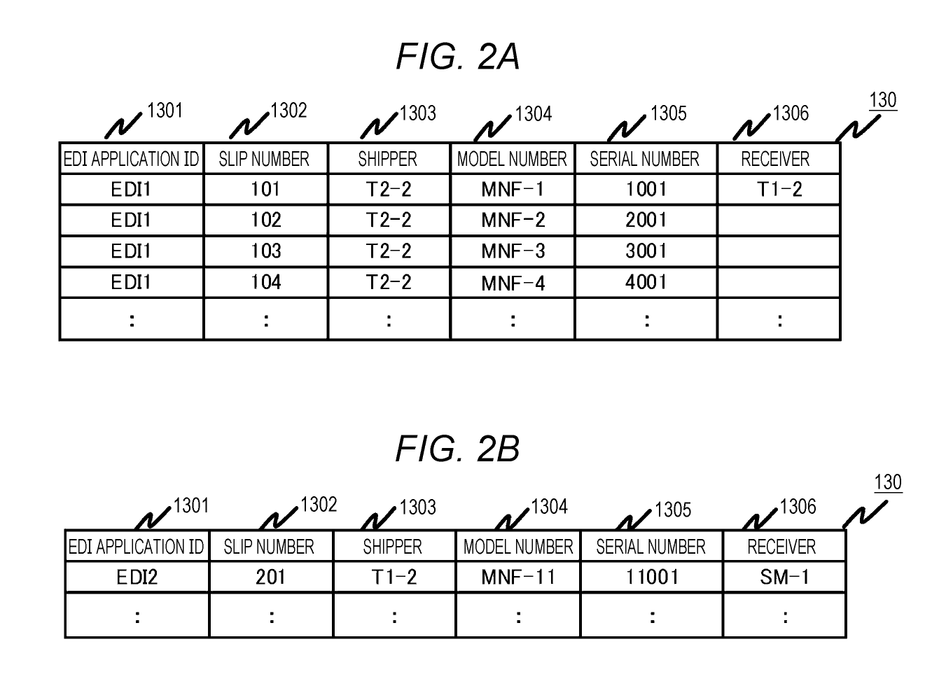

Subsequently, tables used in the access authority management system 20 of the present embodiment will be described. FIGS. 2A and 2B show data configuration examples of the transaction history management table 130 in this embodiment. The transaction history management table 130 is a table provided to the client node 100.

The transaction history management table 130 includes, as component items: a field 1301 for registration of an identifier of the EDI operation application 120 using the transaction history management table 130; a field 1302 for registration of a slip number unique to each transaction of a component and a product, which is generated in an EDI operation; the field 1303 for registration of a shipper in the transaction; a field 1304 for registration of a model number of a component as a transaction object; a field 1305 for registration of a serial number of a component as a transaction object; and the field 1306 for registration of a receiver in the transaction. It should be noted that the field 1306 is empty in a record related to a component that has been shipped but has not reached the arrival of the component.

The specific example of the transaction history management table 130 shown in FIG. 2A shows that a transaction indicated by a slip number “101” has been performed on an EDI operation application having an identifier “EDI 1”, a shipper “T2-2” has shipped a component indicated by a model number “MNF-1” and a serial number “1001” in the transaction, and the component has already been arrived at a receiver “T1-2”.

The specific example of the transaction history management table 130 shown in FIG. 2B shows that a transaction indicated by a slip number “201” has been performed on an EDI operation application having an identifier “EDI 2”, a shipper “T1-2”, which has been the receiver in the above FIG. 2A, has shipped a component indicated by a model number “MNF-11” and a serial number “11001” in the transaction, and the component has already been arrived at a receiver “SM-1”.

That is, a business flow on a supply chain is shown in which the receiver “T1-2” receives the component indicated by the model number “MNF-1” and the serial number “1001” and shipped by the shipper “T2-2”, this component is used to manufacture the component indicated by the model number “MNF-11” and the serial number “11001”, and the component is shipped to the receiver “SM-1”.

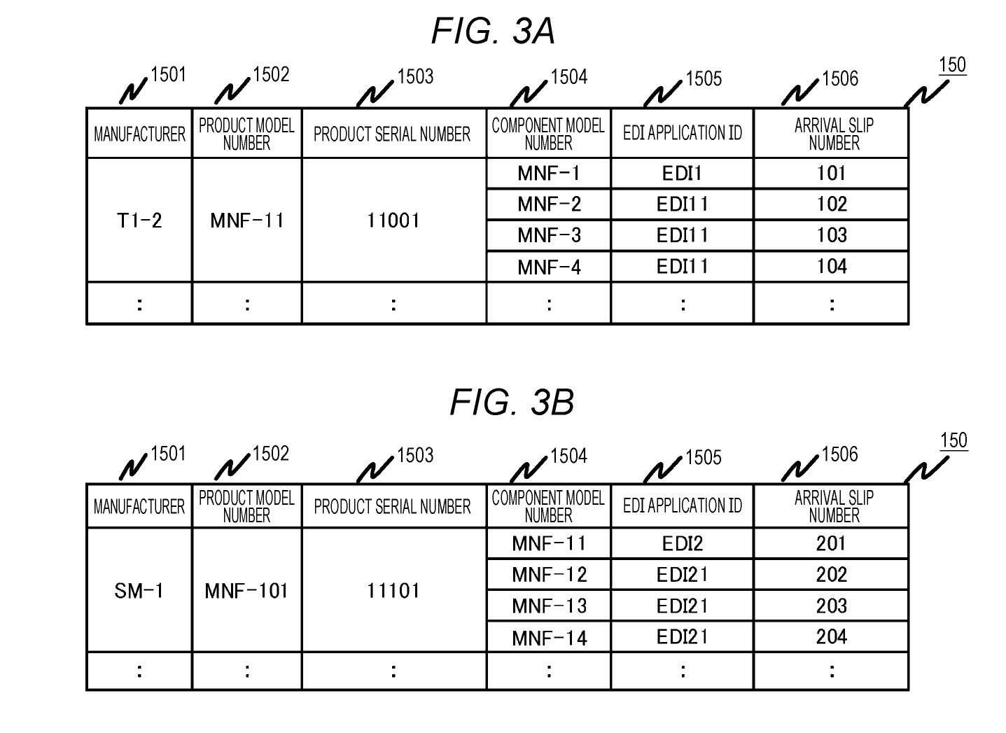

Subsequently, FIGS. 3A and 3B show data configuration examples of the manufacturing history management table 150 in this embodiment. This manufacturing history management table 150 is a table held by the client node 100, and includes, as component items: the field 1501 for registration of a manufacturer of a product as a history registration object, a field 1502 for registration of a model number of a product as a history registration object; a field 1503 for registration of a product serial number; a field 1504 for registration of a model number of a component used in manufacturing of the product; a field 1505 for registration of a model number of an identifier of an EDI operation application used in procurement of the component; and a field 1506 for registration of an arrival slip number in procurement of the component.

The specific example of the manufacturing history management table 150 shown in FIG. 3A shows that, when a business entity having an identifier “T1-2” manufactures a product indicated by the model number “MNF-11” and the serial number “11001”, components indicated by model numbers “MNF-1” to “MNF-4” are used, and a component indicated by the model number “MNF-1” has arrived by a transaction indicated by a slip number “101” on an EDI operation application “EDI 1”.

Whereas, the specific example of the manufacturing history management table 150 shown in FIG. 3B shows that, when a business entity having an identifier “SM-1” manufactures a product indicated by a model number “MNF-101” and a serial number “11101”, components indicated by model numbers “MNF-11” to “MNF-14” are used, and a component indicated by the model number “MNF-11” has arrived by a transaction indicated by the slip number “201” on an EDI business application “EDI 2”.

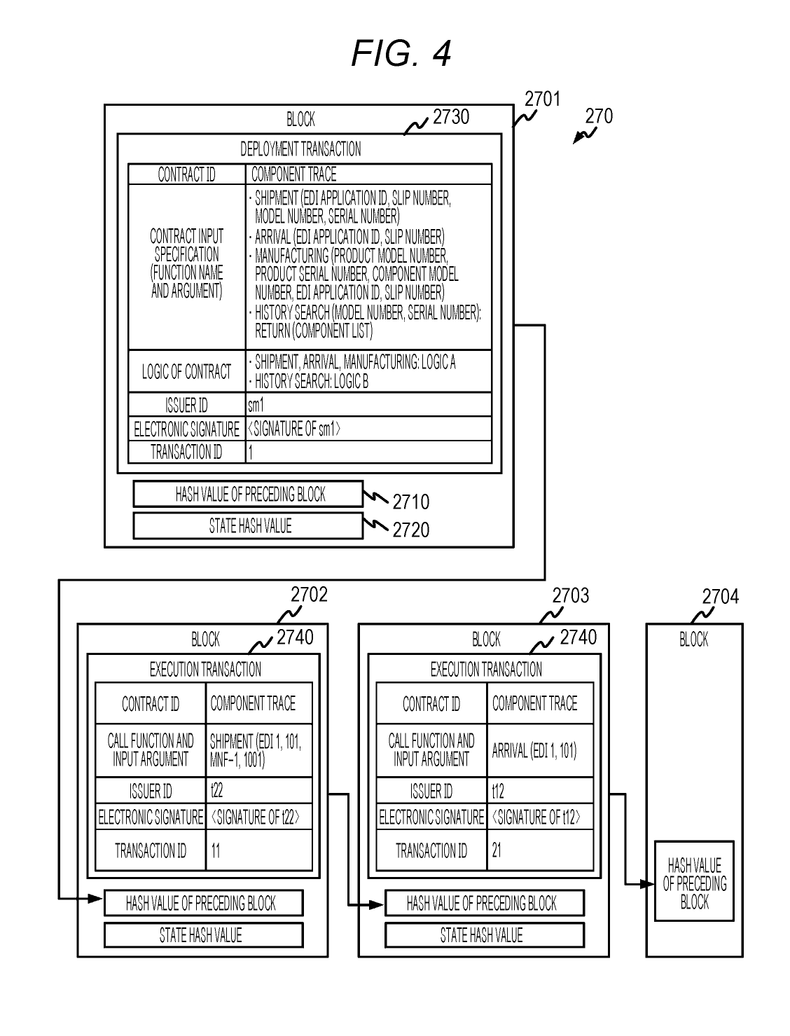

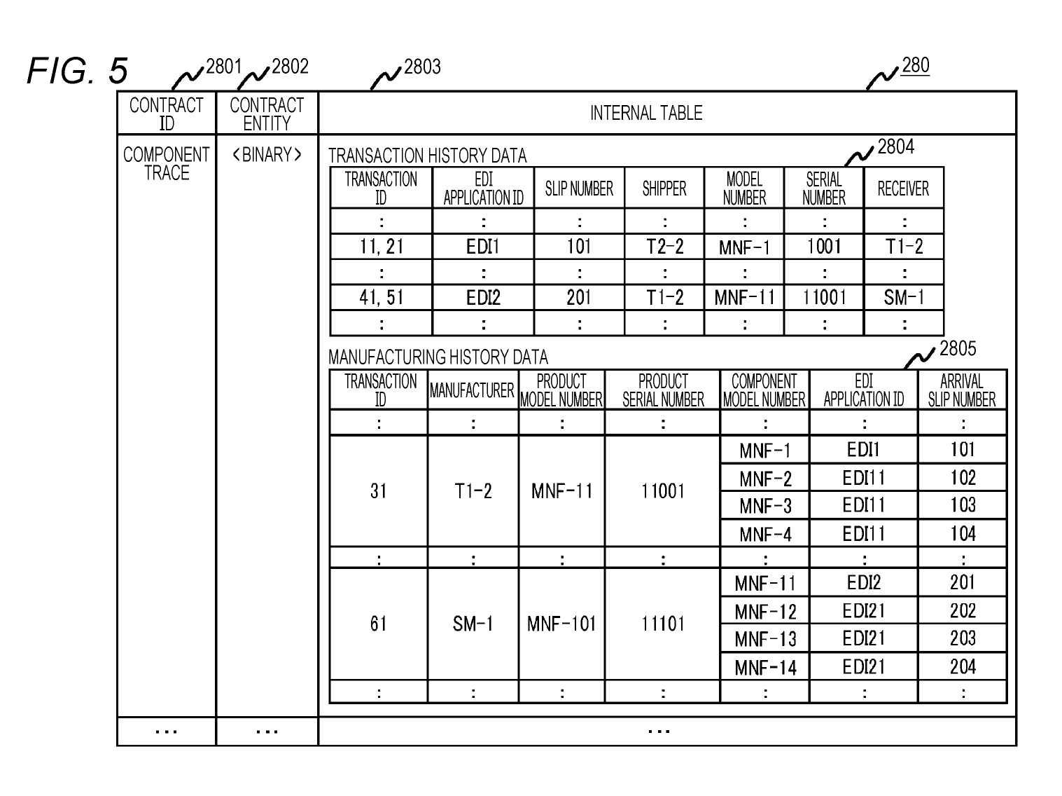

Next, a configuration of the distributed ledger 250 of the distributed ledger node 200 will be described. FIGS. 4 and 5 are examples of a data structure in the distributed ledger 250. Among these, FIG. 4 is a diagram showing an example of the blockchain 270 managed in the distributed ledger 250.

In the distributed ledger management using the BC, a plurality of TXs issued and formed with consensus at a certain time is grouped as a block, and each block has a hash value of a preceding block to be connected in a row and managed. In a case of such management, if the value of the preceding block changes even with 1 bit, hash values of all succeeding blocks will change. Therefore, falsification in the distributed ledger 250 is difficult. In this embodiment, an example is shown in which one block is configured for each TX in order to simplify the description. However, it is also naturally possible to assume a configuration in which a plurality of TXs is collectively stored in one block.

The blockchain 270 shown in FIG. 4 is a series of blocks 2701 to 2704. Further, each block includes TX information on either deployment or execution of the SC. Each block includes a hash value 2710 of a preceding block and includes a hash value 2720 generated from state information to be described later. With the data structure as described above, deployment and execution of the SC are managed as a data chain in BC.

Among these blocks, the block 2701 is an example of a block storing a deployment TX 2730 of the SC. The deployment TX 2730 of the present embodiment includes a contract ID uniquely identifying the smart contract, and logic (e.g., executable binary) of the smart contract. The deployment TX 2730 also includes a contract input specification for a user to grasp a function name and its argument of the smart contract.

In the example of FIG. 4, four of “shipment”, “arrival”, “manufacturing”, and “history search” are defined as function names of an SC having an ID “component trace”, and logic of each function is defined.

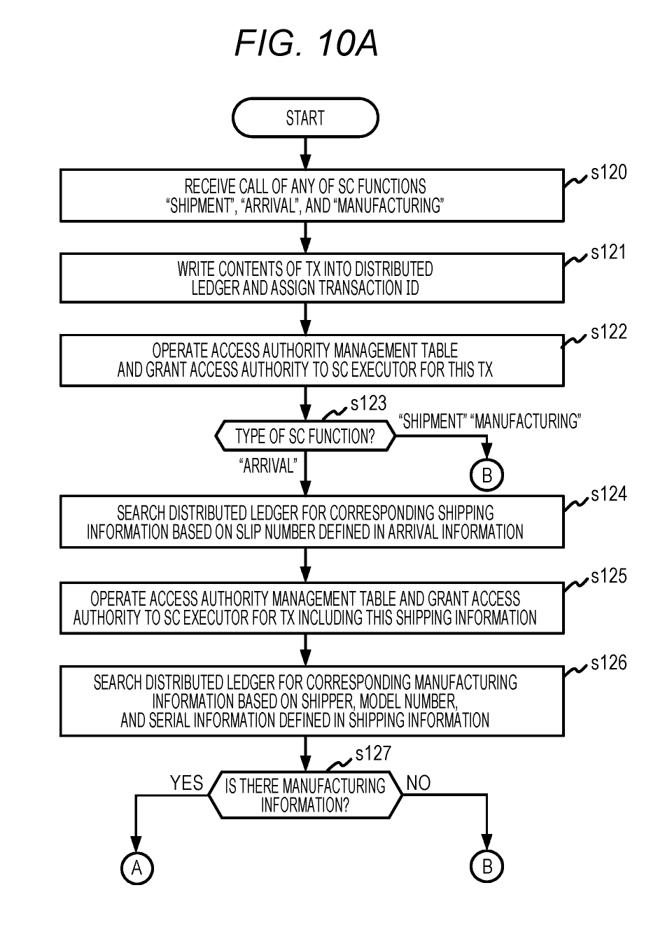

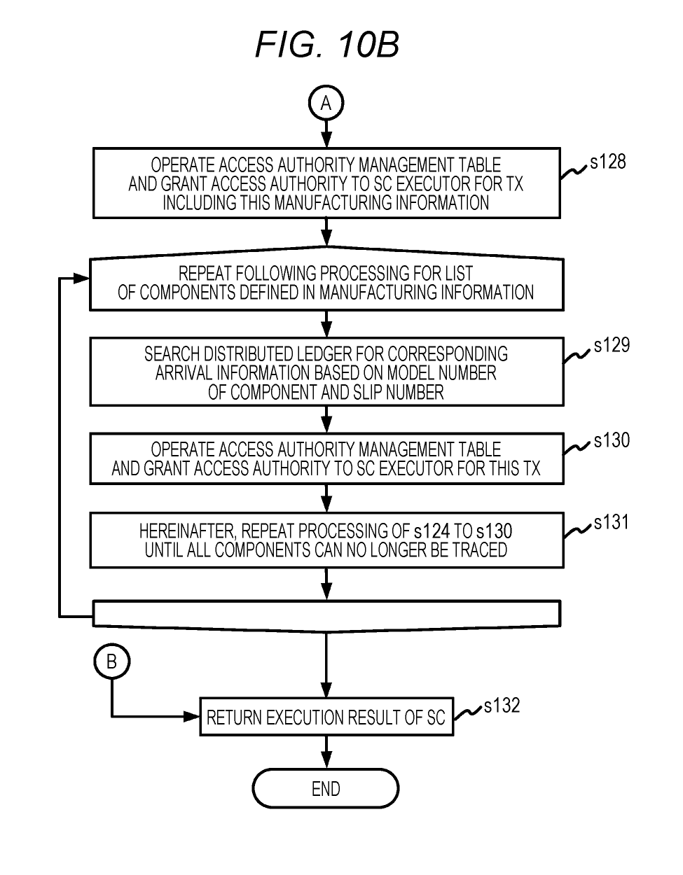

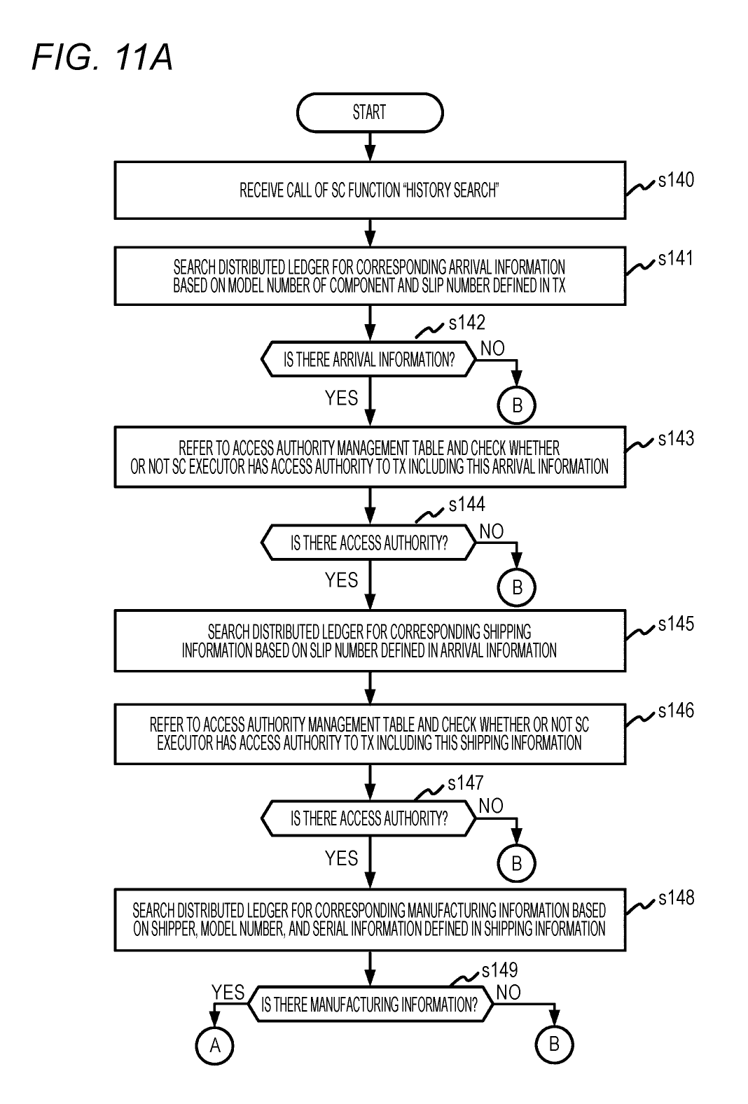

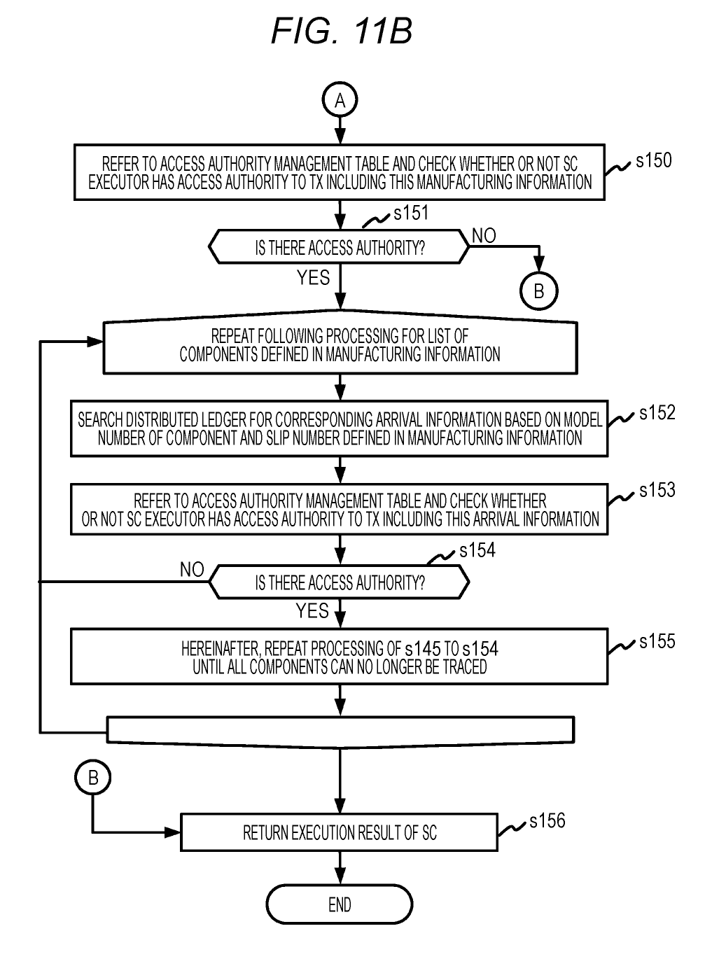

Specifically, “logic A” shown in FIGS. 10A and 10B is defined for “shipment”, “arrival”, and “manufacturing”, while “logic B” shown in FIGS. 11A and 11B is defined for “history search”.

In addition, the deployment TX 2730 includes an issuer ID to identify an issuer of the deployment TX 2730, that is, a provider. The deployment TX 2730 also includes an electronic signature to be used to verify that there is no falsification in such an issuer and data. This electronic signature is generated using a secret key of a consortium participating member (that is, an SC provider and a user) issued by the member management unit 310 of the member management node 300, and verification can be performed with a paired public key. Further, the deployment TX 2730 includes a transaction ID that is a unique identifier of the deployment TX 2730.

The block 2702 is an example of a block storing an execution TX of the SC. The execution TX 2740 of this embodiment includes a contract ID of the smart contract as a calling object, and information on a function name and an argument to be inputted, of the smart contract as a calling object. In this example, a function “shipment” of the SC having the ID “component trace” is called, and its arguments are an EDI application ID, a slip number, a model number, and a serial number, having values “EDI 1”, “101”, “MNF-1”, and “1001”, respectively. Further, the execution TX 2740 includes an issuer ID to identify an issuer of this execution TX 2740, that is, a user. The execution TX 2740 also includes an electronic signature of the user to be used to verify that there is no falsification in the issuer and data. Note that, in addition to the issuer, the information on the consortium participants involved in consensus formation may be managed and retained. In addition, the execution TX 2740 includes a transaction ID that is a unique identifier of this execution TX 2740.

FIG. 5 is a view showing a data configuration of the state information 280 managed in the distributed ledger 250. In distributed ledger management using the BC, it is usually required to trace the BC in order to acquire a (latest) state (e.g., balance of account in a case of a virtual currency). In this case, since processing efficiency is poor, there is a method of caching the latest state information obtained from each block constituting the BC, separately from the BC (e.g., “Hyperledger Fabric”, Internet <URL: http://hyperledger-fabric.readthedocs.io/en/latest/> online, searched on Jun. 30, 2017).

Also in this embodiment, it is assumed that the latest state information 280 is held in the distributed ledger 250. In the present embodiment, it is assumed that a state data area is prepared for each function of the smart contract. The state information 280 holds a contract ID 2801, which is an identifier of the smart contract, and an entity 2802 of the smart contract. This allows the SC execution/management unit 220 of the distributed ledger node 200 to acquire and execute the entity of the smart contract using the contract ID and the function name as keys. Further, the state information 280 includes an internal table 2803 to hold an execution result of the SC. The SC execution/management unit 220 is to update contents of the internal table 2803 each time the TX is executed.

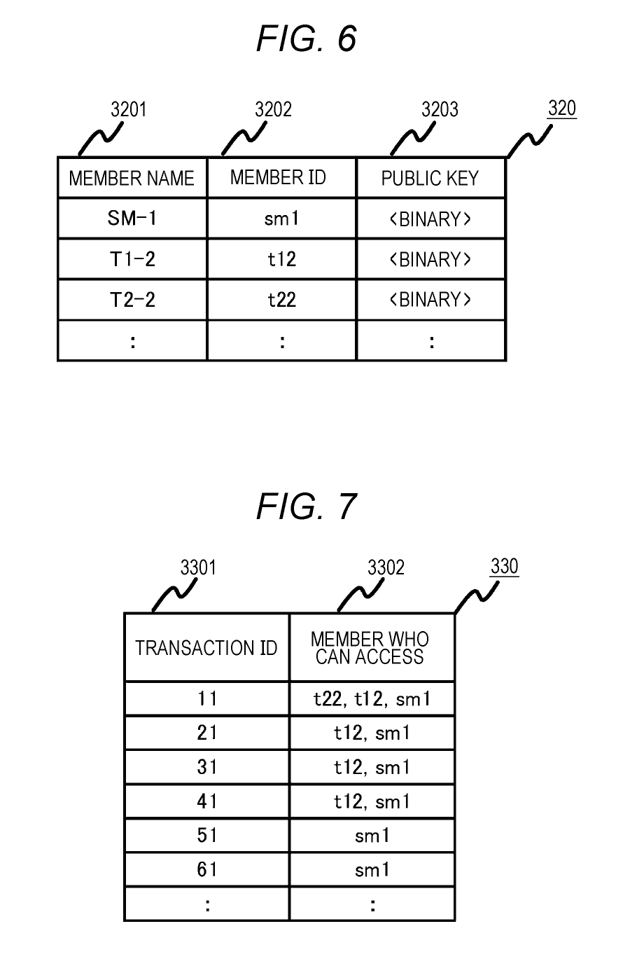

FIG. 6 is a view showing a configuration example of the member management table 320 provided to the member management node 300 of the present embodiment.

This member management table 320 includes, as component items: a field 3201 for registration of a name of a member participating in the consortium; a field 3202 for registration of a member ID as an identifier of the member in the distributed ledger infrastructure; and a field 3203 for registration of a public key when the member performs authentication through the member management unit 310.

FIG. 7 is a view showing a configuration example of the access authority management table 330 provided to the member management node 300 of the present embodiment.

The access authority management table 330 includes, as component items; a field 3301 for registration of an identifier of a transaction stored in the distributed ledger 250 of the distributed ledger node 200; and a field 3302 for registration of an identifier of a member permitted to refer to the transaction.

Hereinafter, an actual procedure of an access authority management method in the present embodiment will be described with reference to the drawings. Various operations corresponding to the access authority management method described below are realized by a program that is read to a memory or the like and executed by an information processing apparatus constituting the access authority management system 20. This program is configured from codes for performing various operations to be described below.

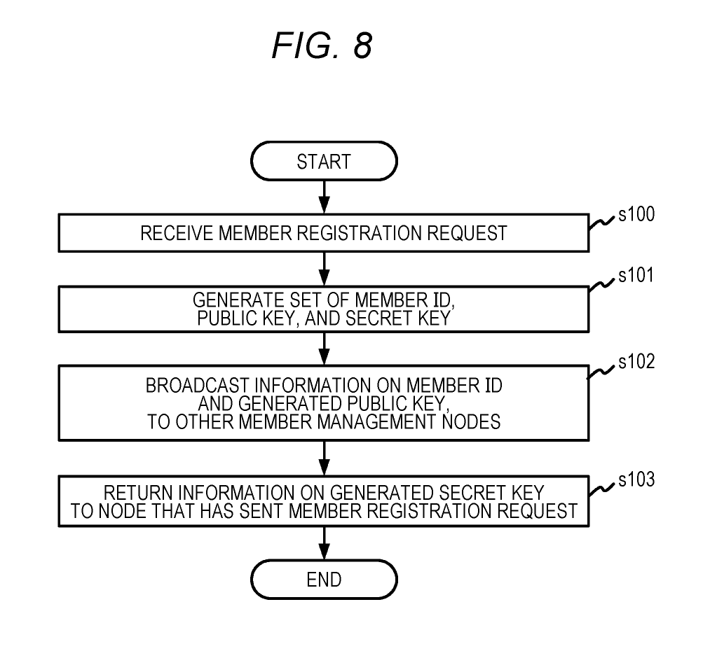

FIG. 8 is a flowchart showing a first flow example of the access authority management method in this embodiment. Specifically, it is a flowchart showing an example of a new registration process of a member who participates in the above consortium.

First, the member management unit 310 of the member management node 300 receives a member registration request from another node such as the client node 100 (s100).

Next, upon receiving the above member registration request, the member management unit 310 assigns a member ID uniquely identifying a request member by an appropriate rule, and generates a pair of a secret key and a public key for the request member (s101). In this case, the member management unit 310 associates the member ID generated in s101 with the public key generated as described above, and registers in the member management table 320.

Next, the member management unit 310 broadcasts the above-mentioned member ID and public key as a new registration object, to other member management nodes 300 (s102).

Information on the member ID and the public key broadcasted here is stored in the access authority management table 330 of each member management node 300.

Furthermore, the member management unit 310 returns the secret key generated in s101 to the node that has transmitted the member registration request in s100 (s103), and ends the processing. Whereas, the node that has received this secret key appropriately stores the secret key as its own secret key in the storage device.

In the present embodiment, it is assumed that authentication of consortium participating members, signature to a TX, control of SC execution authority, and the like are performed by using the pair of the secret key and the public key generated as described above. Specifically, for example, the client node 100 issues a TX having an electronic signature with the issued secret key. In the node that verifies this, identification can be realized by verifying the electronic signature using the above public key. Note that known or well-known technologies may be applied to a technique of generating the pair of the public key and the secret key and a technique of verifying the signature.

In the present embodiment, description is made on the premise that a plurality of member management nodes 300 shares information on the member ID and the public key, but such a member management node 300 may be single. Further, the function and data of the member management node 300 may be held in the distributed ledger node 200. Alternatively, a configuration may be adopted in which a plurality of subgroups is provided under the consortium and a different member management node 300 is selectively used for each subgroup.

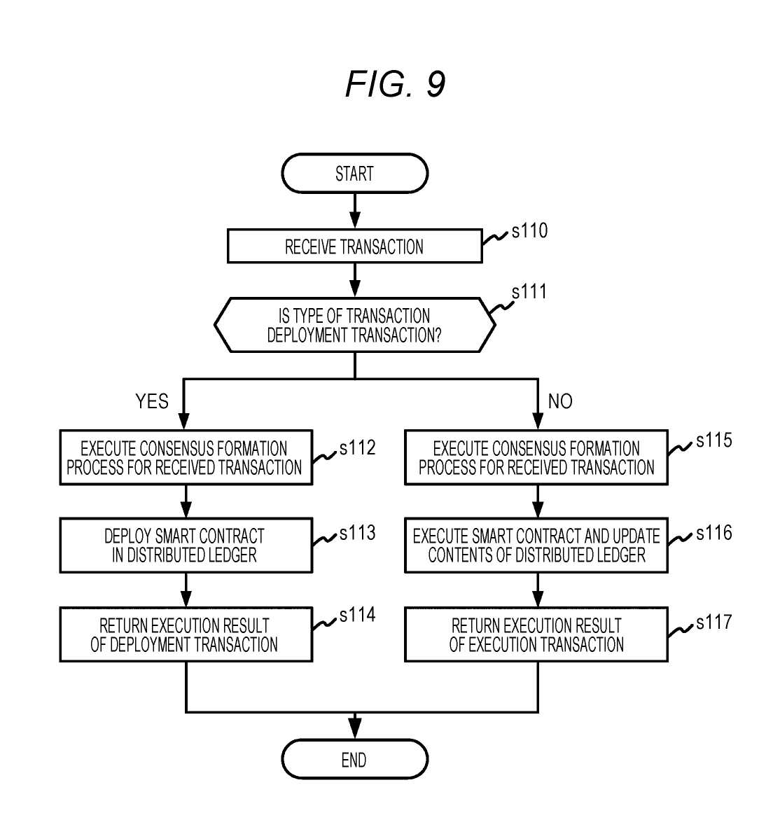

Next, FIG. 9 is a flowchart showing a second flow example of the access authority management method in the first embodiment, and specifically, it is a flowchart showing an example of a TX execution process, that is, deployment and execution of the SC.

In this case, the transaction management unit 230 of the distributed ledger node 200 receives a TX from a TX issuer such as the client node 100 (s110), assigns an ID to the TX, then passes it to the consensus management unit 210, and performs deployment and execution processes of the SC in accordance with a type of the SC and the TX.

Subsequently, when the TX received by the transaction management unit 230 described above is the deployment TX of the SC (s111: YES), the consensus management unit 210 executes a consensus formation process between with other distributed ledger nodes 200 on whether the received TX can be executed or added to the end of the BC as a block (s112).

As a specific consensus forming process method, known or well-known technologies may be applied. Specifically, for example, adopting an algorithm such as one called practical byzantine fault tolerance (PBFT) may be conceivable. The PBFT is an algorithm conditioned on consensus by nodes with a certain percentage (two-thirds) Or more among all nodes (i.e., verification nodes) participating in the consensus formation.

To briefly explain the consensus formation based on this PBFT, the distributed ledger node 200 broadcasts the received TX to all the distributed ledger nodes 200 participating in the network, and each distributed ledger node 200 confirms that no falsification has been made and validates contents of the TX by verifying signature on the TX and broadcasts the confirmation result to other distributed ledger nodes 200. When confirmation can be made by a certain number or more of the distributed ledger nodes 200, the distributed ledger node 200 broadcasts to other distributed ledger nodes 200 that preparation for approval of the TX has been completed. Then, upon confirmation of completion of approval preparation by a certain number or more of the distributed ledger nodes 200, consensus formation is completed.

When consensus formation is completed as described above, the consensus management unit 210 registers the SC included in the TX in the distributed ledger 250 via the SC execution/management unit 220 (s113). Specifically, based on contents of the TX, the contract ID and the contract entity are registered as the state information 280 of the distributed ledger 250, and the block including this deployment TX is added to the end of the BC. At this time, the block is similarly added to other distributed ledger nodes 200 that have formed the consensus.

Finally, the consensus management unit 210 returns an execution result of the deployment TX to the TX issuer (s114).

When the TX received in s110 is the execution TX (s111: NO), the consensus management unit 210 executes consensus formation process (s115) similarly to the deployment TX. This consensus formation process is similar to that in s112.

Upon completion of consensus formation at s115 described above, the consensus management unit 210 executes the SC and updates contents of the distributed ledger 250 via the SC execution/management unit 220 (s116).

Specifically, the consensus management unit 210 gives a call function and an input argument specified in the execution TX to an SC having the contract ID specified in the execution TX (assuming that it is already registered), to execute the SC. Then, based on the result, the contents of the distributed ledger 250 are updated.

The above function is roughly divided into one for writing the TX and one for reading the TX with conditions specified. An example of execution details of the SC will be described with reference to FIGS. 10A and 10B and FIGS. 11A and 11B.

The consensus management unit 210 in s116 updates the state information 280 related to this smart contract based on an execution result of the SC, and adds the execution TX as the last block of the blockchain 270.

In this case, when the executed function is for writing the TX, the block is similarly added to other distributed ledger nodes 200 that have formed the consensus. However, among the processes shown in FIGS. 10A and 10B, an instruction of granting access authority to the member management unit 310 of the member management node 300 may be omitted.

Finally, the consensus management unit 210 returns an execution result (e.g., a return value of the function) of the execution TX described above to the TX issuer (s117), and ends the processing.

In this embodiment, the distributed ledger node 200 is configured to execute a broadcast process in s112 and s115, but an independent node specialized for the broadcast process may be configured to perform the process. In addition, a method other than PBFT may be used as means of consensus formation.

FIGS. 10A and 10B are flowcharts showing an example of an internal process at a time of calling TX writing functions “shipment”, “arrival”, and “manufacturing”, among functions of an SC having the ID “component trace” shown in the blockchain 270 of FIG. 4.

In this case, upon receiving a call of one of “shipment”, “arrival”, or “manufacturing” of the “component trace” SC function as the TX formed with consensus (s120), the SC execution/management unit 220 of the distributed ledger node 200 executes a process defined in the SC. A specific internal process is shown below.

First, the SC execution/management unit 220 updates the state information 280 related to this smart contract based on the content of the TX. As shown in items 2804 to 2805 in the state information 280 exemplified in FIG. 5, the internal table 2803 of the state information 280 has a separate table for each function such as “shipment”, “arrival”, or “manufacturing”. Therefore, the SC execution/management unit 220 adds the information specified by the argument of the TX, to the table corresponding to the called function.

Next, the SC execution/management unit 220 adds the execution TX as the last block of the blockchain 270 (s121). At this time, the SC execution/management unit 220 registers a hash value of a preceding block, the hash value generated from the state information, and the transaction ID together.

Next, the SC execution/management unit 220 instructs the member management unit 310 of the member management node 300 to grant access authority to the TX to the SC executor. Whereas, the member management unit 310 operates the access authority management table 330 and grants access authority of the SC executor for the TX (s122).

Next, when the function of the called SC described above is either “shipment” or “manufacturing” (s123: “shipment”, “manufacturing”), the SC execution/management unit 220 advances the processing to s132. On the other hand, when the function of the called SC is “arrival” (s123: “arrival”), the SC execution/management unit 220 advances the processing to s124.

The SC execution/management unit 220 in s124 searches the distributed ledger 250 for corresponding shipping information based on a slip number defined in the arrival information included in the TX (s124).

Next, the SC execution/management unit 220 instructs the member management unit 310 of the member management node 300 to grant, to the SC executor, access authority to the TX that defines the shipping information. On the other hand, the member management unit 310 operates the access authority management table 330 and grants access authority of the SC executor for the TX (s125).

Next, the SC execution/management unit 220 searches the distributed ledger 250 for corresponding manufacturing information based on a shipper, a model number, and serial information defined in the above shipping information (s126).

As a result of this search, when relevant manufacturing information does not exist in the distributed ledger 250 (s127: NO), the SC execution/management unit 220 advances the processing to s132.

On the other hand, as a result of the above search, when relevant manufacturing information exists in the distributed ledger 250 (s127: YES), the SC execution/management unit 220 instructs the member management unit 310 of the member management node 300 to grant, to the SC executor, access authority to the TX that defines the manufacturing information. In this case, the member management unit 310 operates the access authority management table 330 and grants access authority of the SC executor for the TX (s128).

Next, the SC execution/management unit 220 repeats the following processing for a list of components defined in the above manufacturing information (s129 to s130).

First, the SC execution/management unit 220 searches the distributed ledger 250 for corresponding arrival information based on a model number of the component and a slip number defined in the above manufacturing information (s129).

Next, the SC execution/management unit 220 instructs the member management unit 310 of the member management node 300 to grant, to the SC executor, access authority to the TX that defines the arrival information. In this case, the member management unit 310 operates the access authority management table 330 and grants access authority of the SC executor for the TX (s130).

After that, the SC execution/management unit 220 repeats the processing of s124 to s130 described above until all the components can no longer be traced (s131).

Finally, the SC execution/management unit 220 returns an execution result (e.g., success) of this SC (s132), and ends the processing.

FIGS. 11A and 11B are flowcharts showing an example of an internal process at a time of calling a TX reading function “history search” among the functions of the SC having the ID “component trace” shown in the blockchain 270 of FIG. 4.

In this case, upon receiving a call of the “history search” of the “component trace” SC function (s140) as the TX formed with consensus, the SC execution/management unit 220 executes a process defined in the SC. A specific internal process is shown below.

First, the SC execution/management unit 220 searches the distributed ledger 250 for corresponding arrival information based on a model number of the component and a slip number defined in the execution TX (s141).

As a result of the above search, when relevant arrival information does not exist in the distributed ledger (s142: NO), the SC execution/management unit 220 advances the processing to s156.

On the other hand, as a result of the above search, when relevant receipt information exists in the distributed ledger (s142: YES), the SC execution/management unit 220 inquires of the member management unit 310 of the member management node 300 whether or not the SC executor has access authority to the TX that defines the arrival information. In this case, the member management unit 310 refers to the access authority management table 330 and checks whether or not the SC executor has access authority to the TX (s143).

As a result of this checking, when there is no access authority to the TX (s144: NO), the SC execution/management unit 220 advances the processing to s156.

On the other hand, as a result of the above checking, when there is access authority to the TX (s144: YES), the SC execution/management unit 220 searches the distributed ledger 250 for corresponding shipping information based on a slip number defined in the arrival information included in the above TX (s145).

Next, the SC execution/management unit 220 inquires of the member management unit 310 of the member management node 300 whether or not the SC executor has access authority to the TX that defines the shipping information. In this case, the member management unit 310 refers to the access authority management table 330 and checks whether or not the SC executor has access authority to the TX (s146).

As a result of the above checking, when there is no access authority to the TX (s147: NO), the SC execution/management unit 220 advances the processing to s156.

On the other hand, as a result of the above checking, when there is access authority to the TX (s147: YES), the SC execution/management unit 220 searches the distributed ledger 250 for corresponding manufacturing information based on a shipper, a model number, and serial information defined in the above shipping information (s148).

As a result of this search, when relevant manufacturing information does not exist in the distributed ledger 250 (s149: NO), the SC execution/management unit 220 advances the processing to s156.

On the other hand, as a result of the above search, when relevant manufacturing information exists in the distributed ledger 250 (s149: YES), the SC execution/management unit 220 inquires of the member management unit 310 of the member management node 300 whether or not the SC executor has access authority to the TX that defines the manufacturing information. In this case, the member management unit 310 refers to the access authority management table 330 and checks whether or not the SC executor has access authority to the TX (s150).

As a result of the above checking, when there is no access authority to the TX (s151: NO), the SC execution/management unit 220 advances the processing to s156.

On the other hand, as a result of the above checking, when there is access authority to the TX (s151: YES), the SC execution/management unit 220 repeats the following processing (s152 to s155) for a list of components defined in the above manufacturing information.

In this case, first, the SC execution/management unit 220 searches the distributed ledger 250 for corresponding arrival information based on a model number of the component and a slip number defined in the above manufacturing information (s152).

Next, for relevant arrival information, the SC execution/management unit 220 inquires of the member management unit 310 of the member management node 300 whether or not the SC executor has access authority to the TX that defines the arrival information. In this case, the member management unit 310 refers to the access authority management table 330 and checks whether or not the SC executor has access authority to the TX (s153).

As a result of the above checking, when there is no access authority to the TX (s154: NO), the SC execution/management unit 220 proceeds to processing for the next component defined in the above list. After that, the SC execution/management unit 220 repeats the processing of s145 to 154 until all the components can no longer be traced (s155).

Finally, the SC execution/management unit 220 returns (s156), as an execution result of this SC, history information on shipment, arrival, and manufacturing of the component acquired in the series of processes from s141 to s155, and ends the processing.

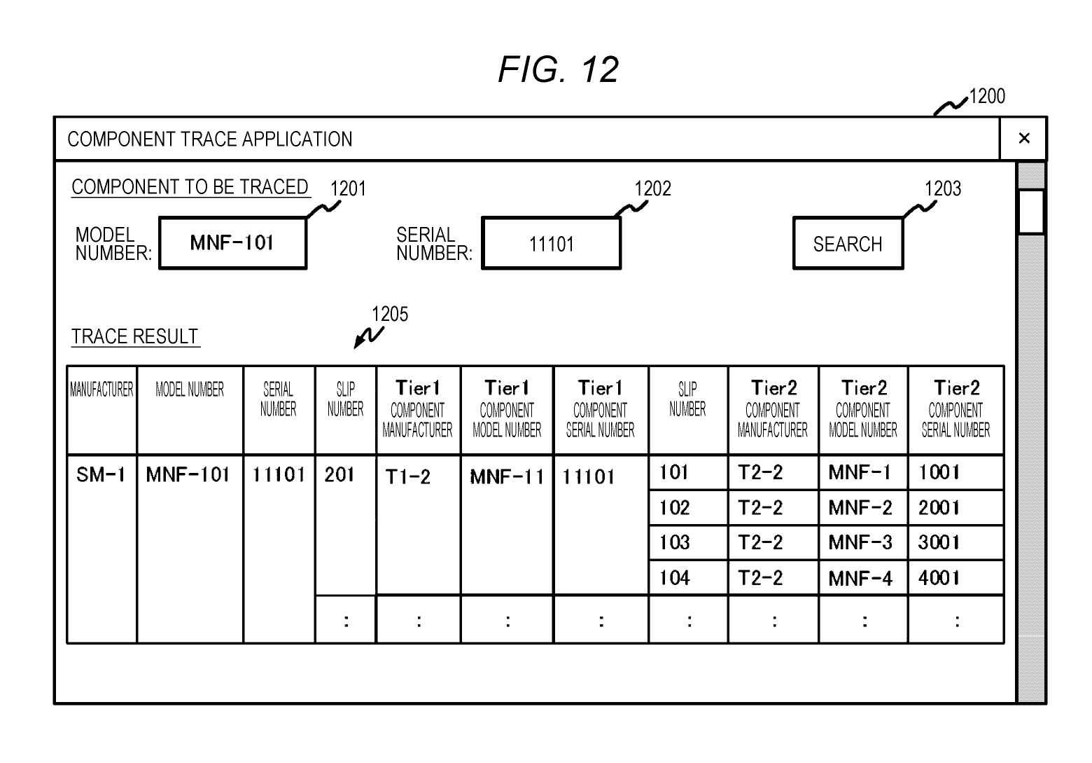

A specific GUI for a user to obtain the history information in this way will be described. FIG. 12 shows an example of a display screen 1200 of the component trace application 160. On an upper part of the screen 1200, there are forms 1201 and 1202 to be input with a model number and a serial number of a product using a component whose history is to be searched for, and a “search” button 1203.

When a user inputs the model number and the serial number of the product to the above-mentioned forms 1201 and 1202 at a node operated by the user (e.g., the client node 100) and presses the “search” button 1203, each of the above flows is executed, and history information on shipment, arrival, and manufacturing of the specified product is displayed as a trace result 1205 at a lower part of the screen. This display information can be acquired by the component trace application 160 executing the SC for the transaction management unit 230 of the distributed ledger node 200 and calling the function “history search”.

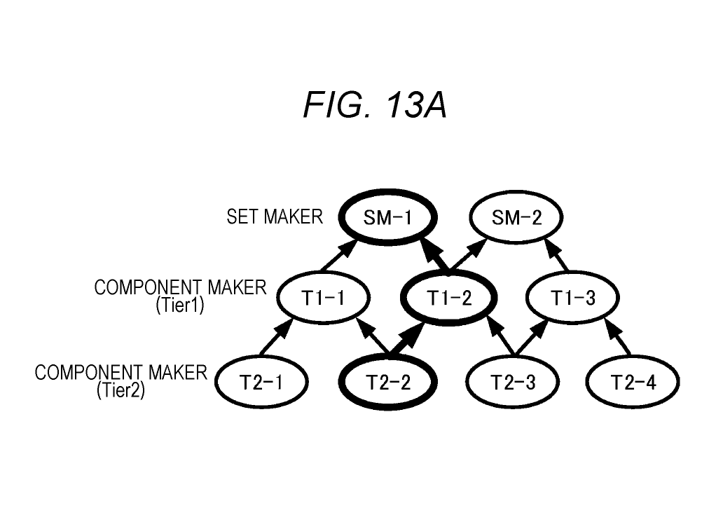

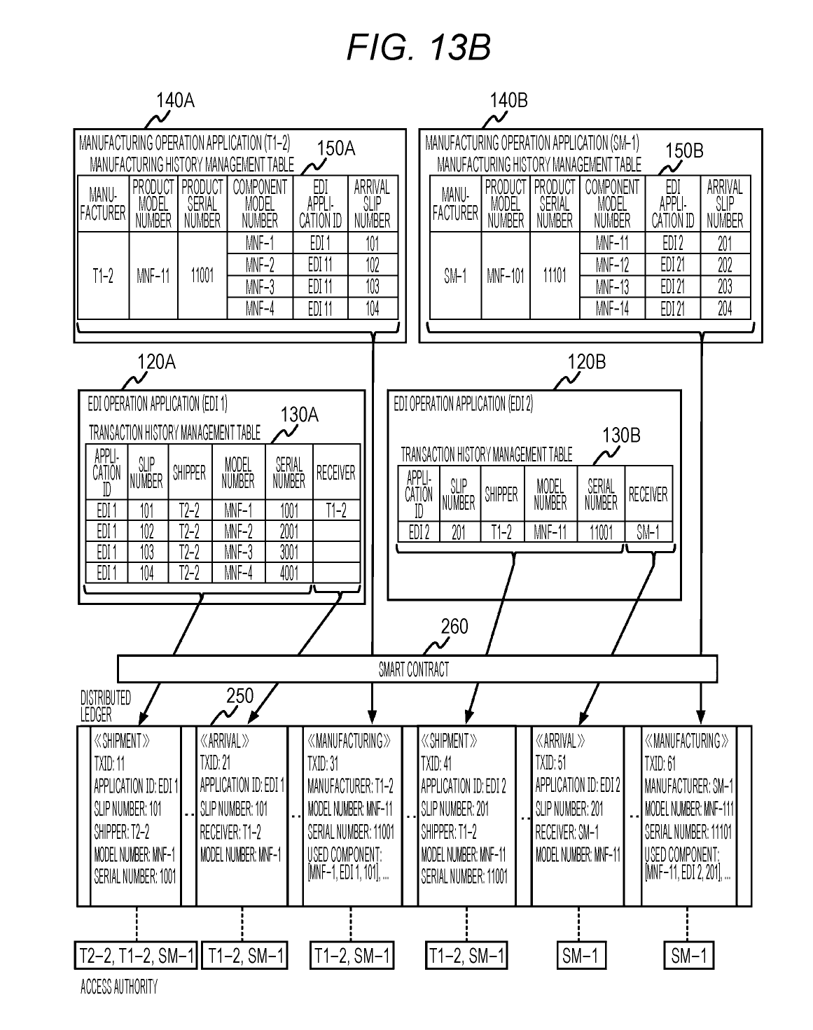

Here, with use of FIGS. 13A and 13B each, the processing of the first embodiment shows how the node creates data on the distributed ledger 250 in response to the input of the user, and performs a history search of a component through the component trace application 160.

FIG. 13A is a schematic diagram showing business entities participating in the consortium in this embodiment. Business entities are divided into a “set maker” that produces final products such as automobiles that directly reach consumers, “component maker (Tier 1)” that manufactures components constituting the final product, as a subcontractor of the set maker, and “component maker (Tier 2)” that produces finer components, as a subcontractor of the Tier 1. That is, these business entities constitute a supply chain related to automobile manufacturing.

In the figure, there are “SM-1” and “SM-2” as set makers, “T1-1” to “T1-3” as Tier 1 makers, and “T2-1” to

“T2-4” as Tier 2 makers. Arrows in the figure indicate dependence relationships on delivery of components.

Whereas, FIG. 13B is a schematic diagram showing a process of exchanging information held by each node described in FIGS. 1 to 7. Hereinafter, description is given to a process in which a Tier 2 maker “T2-2” ships a component, a Tier 1 maker “T1-2” receive the component and combines with another component to manufacture a new component to ship, and a set maker “SM-1” receives the component manufactured by the “T1-2” above. It is assumed that an execution subject of each process is a node.

First, the “T2-2” ships a component indicated by a model number “MNF-1” and a serial number “1001” and registers its information in the transaction history management table 130A through the EDI operation application 120A. A slip number of the transaction is “101”. In addition, the EDI operation application 120A registers the shipping information in the distributed ledger 250 by calling the function “shipment” of the smart contract 260 and executing a TX. A transaction ID at this time is “11”.

Next, the smart contract updates the access authority management table 330 through the member management unit 310 of the member management node 300, and grants access authority from the “T2-2” to the transaction.

Next, the “T1-2” receives the component indicated by the model number “MNF-1” and the serial number “1001” and registers its information in the transaction history management table 130A through the EDI operation application. Further, the EDI operation application registers the shipping information in the distributed ledger 250 by calling the function “arrival” of the smart contract and executing a TX. A transaction ID at this time is “21”.

Next, the smart contract executes a process shown in

FIGS. 10A and 10B, updates the access authority management table 330 of the member management node 300, and grants access authority from the “T1-2” to the transaction (ID: 21) and to the transaction (ID: 11) that has recorded a shipping history having the same ledger number.

Next, the “T1-2” uses the component indicated by the model number “MNF-1” and received with the transaction indicated by a slip number “101” at a time of arrival, to produce a product indicated by the model number “MNF-11” and the serial number “11001”, and registers its information in the manufacturing history management table 150A through a manufacturing operation application 140A.

The manufacturing operation application 140A registers the manufacturing information in the distributed ledger 250 by calling the function “manufacturing” of the smart contract and executing a TX. A transaction ID at this time is “31”.

Next, the smart contract updates the access authority management table 330 of the member management node 300, and grants access authority from the “T1-2” to the transaction.

Next, the “T1-2” receives the above produced component indicated by the model number “MNF-11” and the serial number “11001” and registers its information in the transaction history management table 130B through an EDI operation application 120B. A slip number of the transaction is “201”. In addition, the EDI operation application 120B registers the shipping information in the distributed ledger 250 by calling the function “shipment” of the smart contract and executing a TX. A transaction ID at this time is “41”.

Next, the smart contract updates the access authority management table 330 of the member management node 300, and grants access authority from the “T1-2” to the transaction.

Next, the “SM-1” receives the component indicated by the model number “MNF-11” and the serial number “11001”, and registers its information in the transaction history management table 130B through the EDI operation application. The EDI operation application registers the shipping information in the distributed ledger 250 by calling the function “arrival” of the smart contract and executing a TX. A transaction ID at this time is “51”.

Next, the smart contract executes a process shown in FIGS. 10A and 10B, updates the access authority management table 330 of the member management node 300, and grants access authority from the “SM-1” to this transaction (ID: 51), a transaction (ID: 41) recorded with an arrival history having a slip number described in the above shipping history, a transaction (ID: 31) recorded with a manufacturing history having a model number and a serial number described in the above shipping history, a transaction (ID: 21) recorded with an arrival history having a slip number described in the above manufacturing history, and a transaction (ID: 11) recorded with an arrival history having a slip number described in the above shipping history.

Next, the “SM-1” uses the component indicated by the model number “MNF-11” and received with the transaction indicated by the slip number “201” at a time of arrival, to produce a product indicated by a model number “MNF-21” and the serial number “11101”, and registers its information in the manufacturing history management table 150B through a manufacturing operation application 140B. The manufacturing operation application 140B registers the manufacturing information in the distributed ledger 250 by calling the function “manufacturing” of the smart contract and executing a TX. A transaction ID at this time is “61”.

Next, the smart contract updates the access authority management table 330 of the member management node 300, and grants access authority from the “SM-1” to the transaction.

As a result, records shown in FIG. 5 are generated in the internal table of the state information 280 in the distributed ledger node 200, while records shown in a first row to a sixth row in FIG. 7 are generated in the access authority management table 330 of the member management node 300.

At any time after this, if any problem occurs in the product indicated by the model number “MNF-21” and the serial number “11101”, the “SM-1” is to use the component trace application 160 to search a list of components constituting the product and the transaction history.

In this case, when the user instructs the search at a node, the component trace application 160 of the node executes the SC for the transaction management unit 230 of the distributed ledger node 200, and calls the function “history search”. As a result, as shown in FIG. 12, history information on shipment, arrival, and manufacturing of the specified product is displayed at a lower part of the screen.

As described above, by using the present invention, when operation information such as a sales or manufacturing history of a plurality of business entities coexists on the ledger in the consortium distributed ledger system, access control can be performed such that each business entity can exclusively access minimum necessary information.

At this time, defining and embedding a policy of granting access authority in the SC enables execution in concert after forming consensus among the business entities on the policy of granting access authority. In addition, even in the presence of a business entity with malicious intent to obtain access authority illegally, normal granting of access authority can be maintained within a range guaranteed by a consensus algorithm of the distributed ledger system.

### Second Embodiment

In a second embodiment, description is given to a method of holding, in a distributed ledger 250 of a distributed ledger node 200, information corresponding to the access authority management table 330 held in the member management node 300 in the above-described first embodiment.

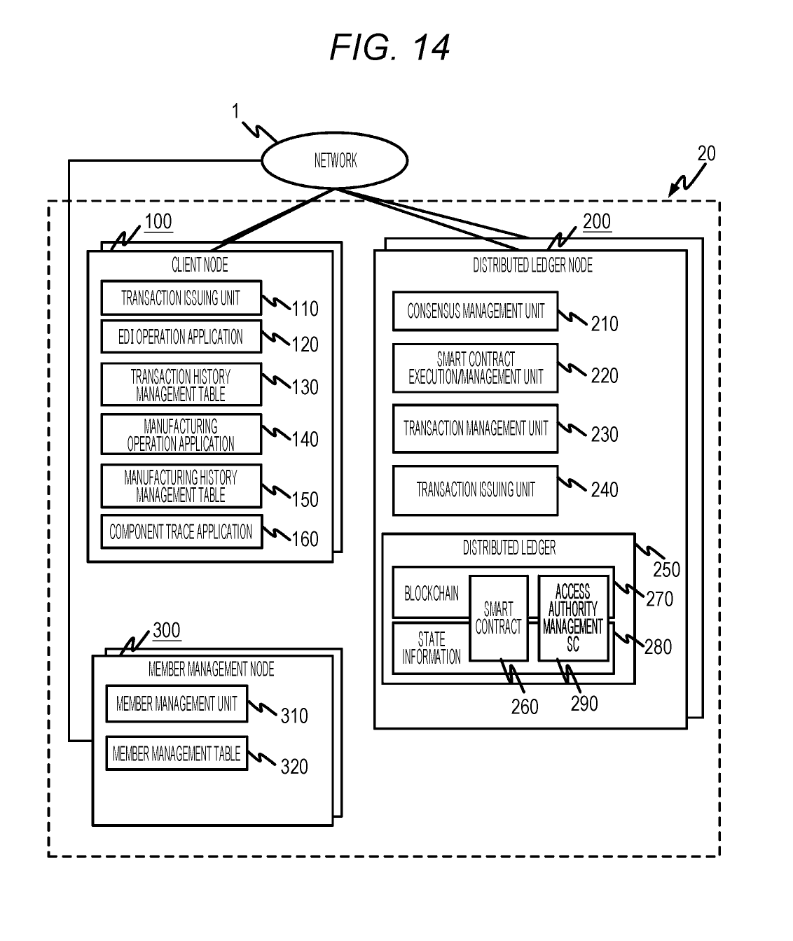

FIG. 14 schematically shows a configuration example of an access authority management system 20 assumed in the second embodiment. On the distributed ledger 250 of the distributed ledger node 200 in this case, a smart contract 260 related to an operation and a TX result by an SC is stored and managed, and a smart contract 290 for access authority management and a TX result by this smart contract 290 for access authority management are stored and managed. As its data structure, similarly to the first embodiment, it is assumed that a history of a TX is set as a blockchain 270, and state information 280 based on an execution result of the TX is held in a table format.

A configuration of other parts is similar to that of the first embodiment, except that a member management node 300 does not have an access authority management table 330.

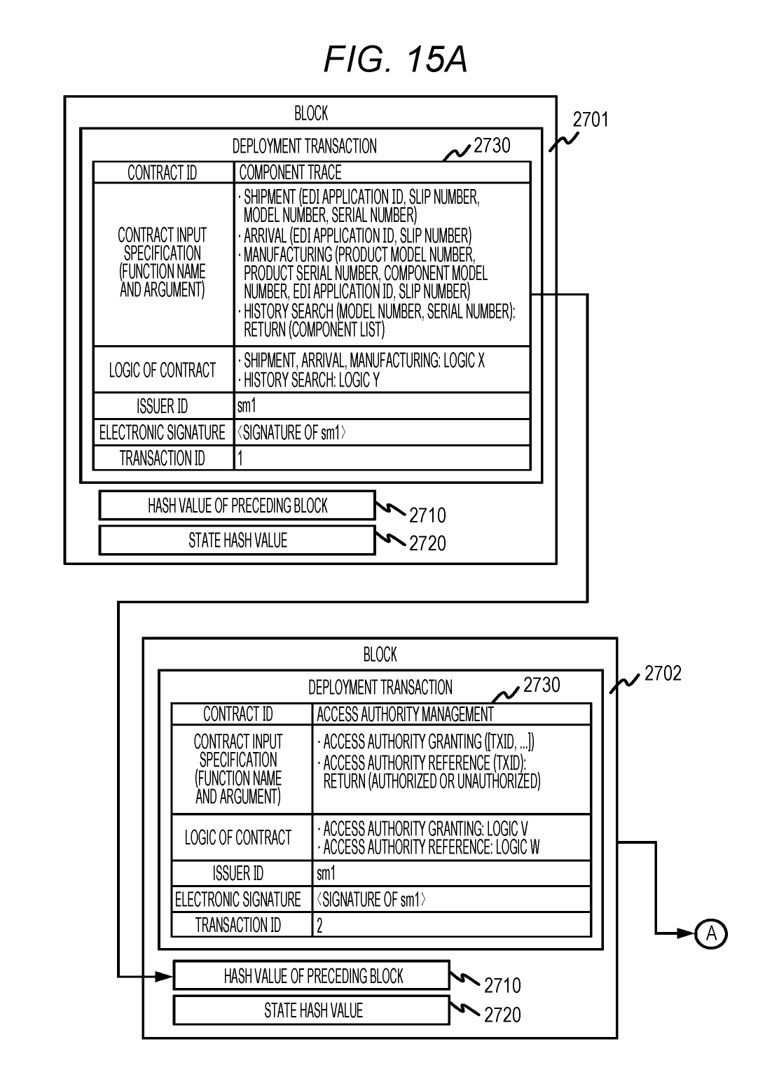

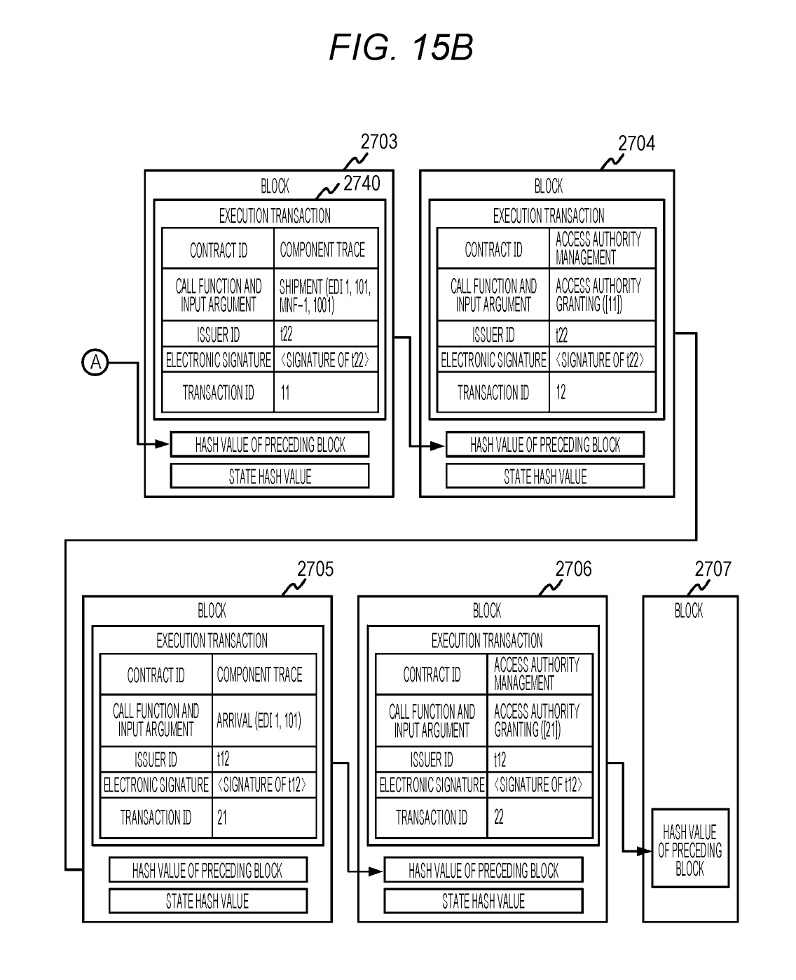

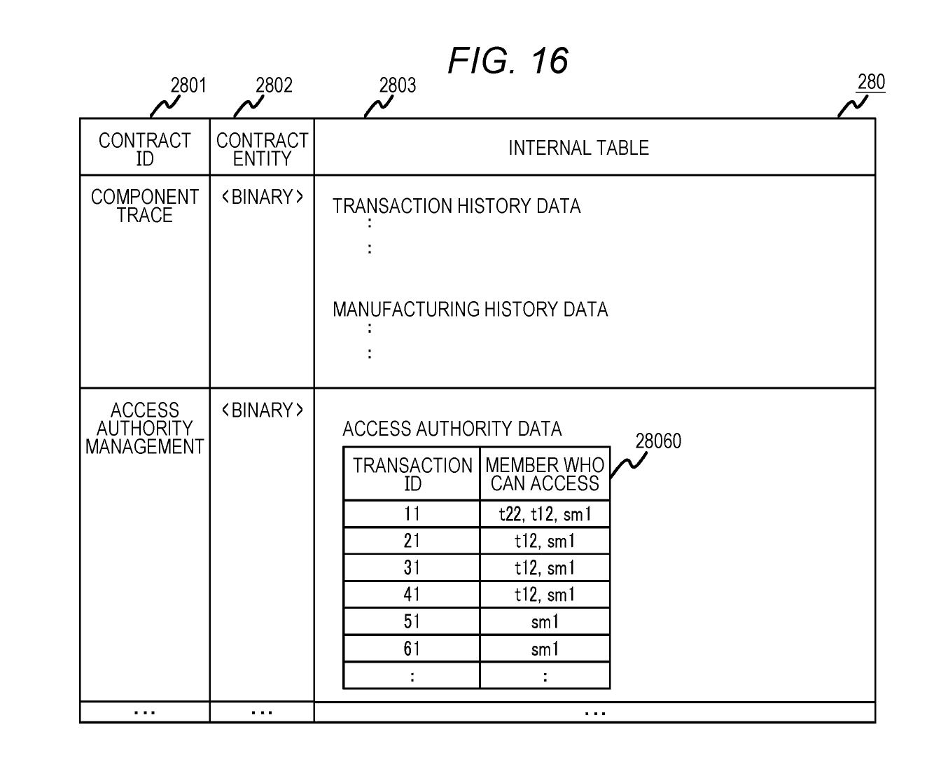

FIGS. 15A, 15B, and 16 are examples of a data structure stored in the distributed ledger 250 of the distributed ledger node 200 in the second embodiment.

FIGS. 15A and 15B show an example of the blockchain 270, which is one of data structures managed on the distributed ledger 250. This blockchain 270 is made up of a series of blocks 2701 to 2707. Each of these blocks includes TX information of either deployment or execution, of a component trace SC or of an access authority management SC.

Among them, the block 2701 is an example of a block storing a deployment TX of a component trace SC. Similarly to the first embodiment, a deployment TX 2730 of this embodiment includes a contract ID uniquely identifying a smart contract, and an entity of the smart contract. The deployment TX 2730 also includes a contract input specification for a user to grasp a function name and its argument of the smart contract.

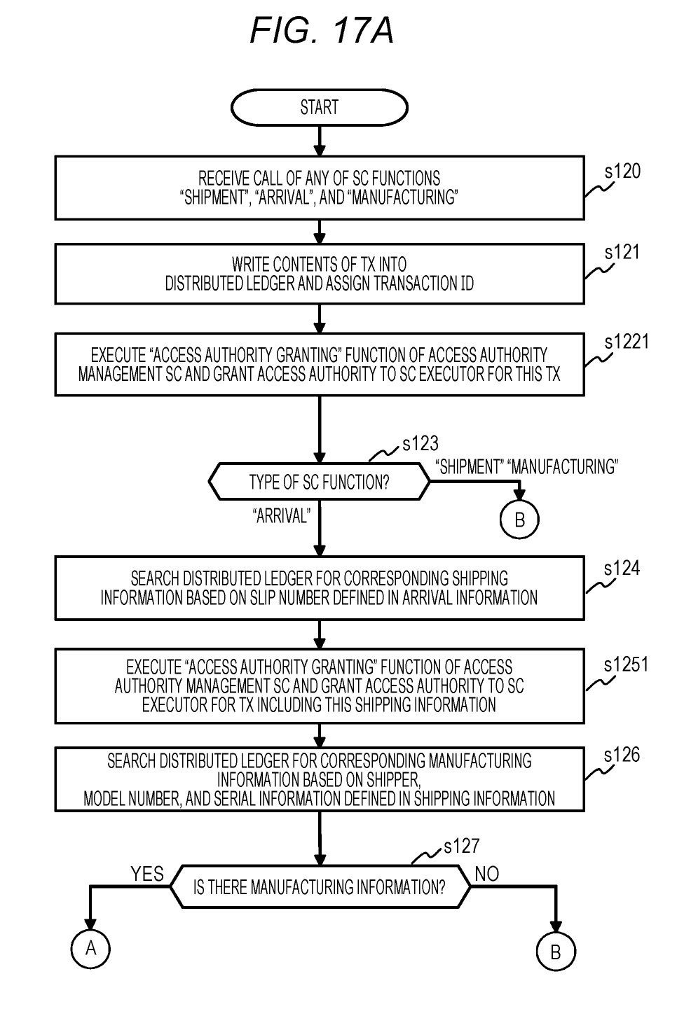

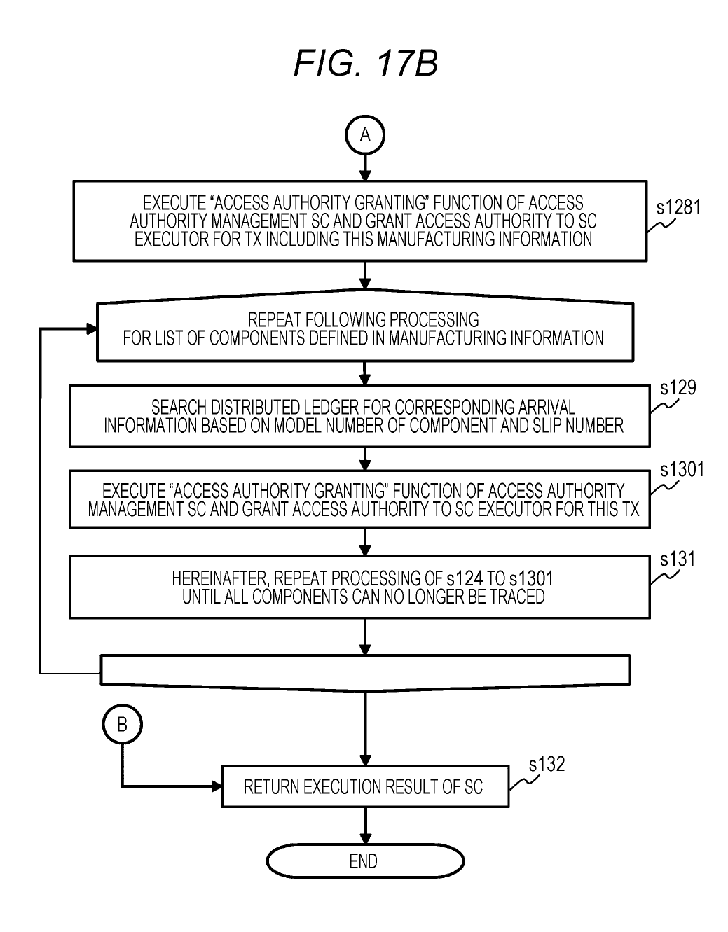

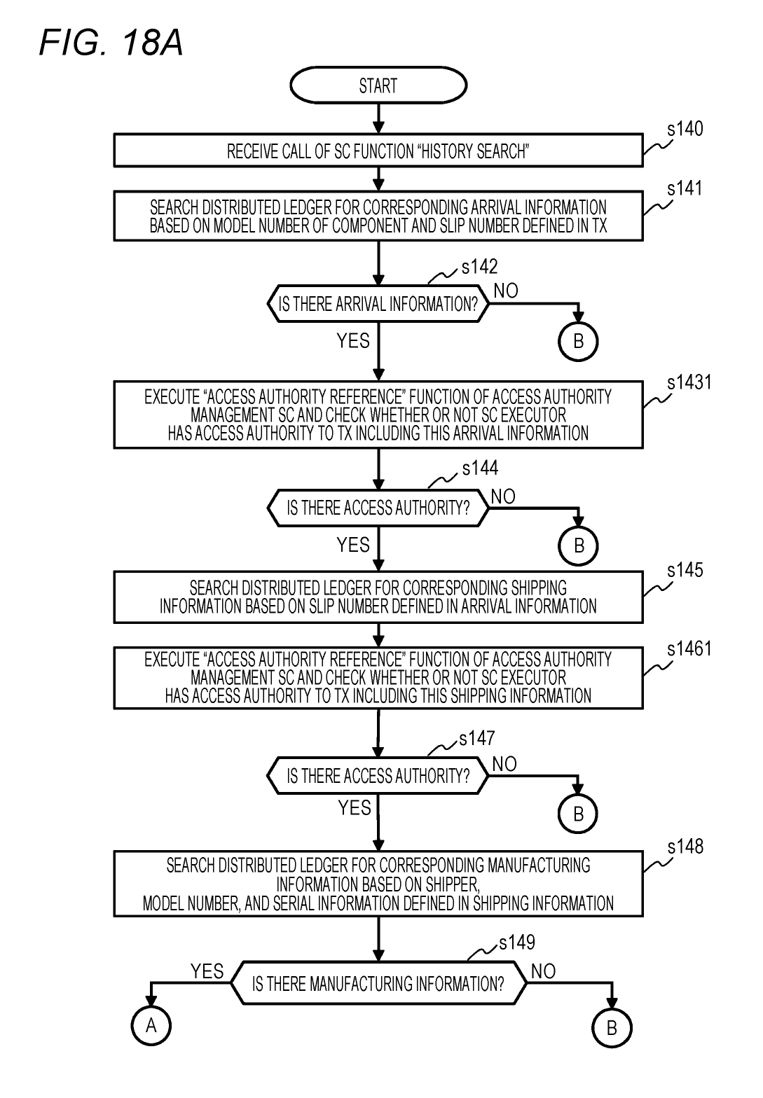

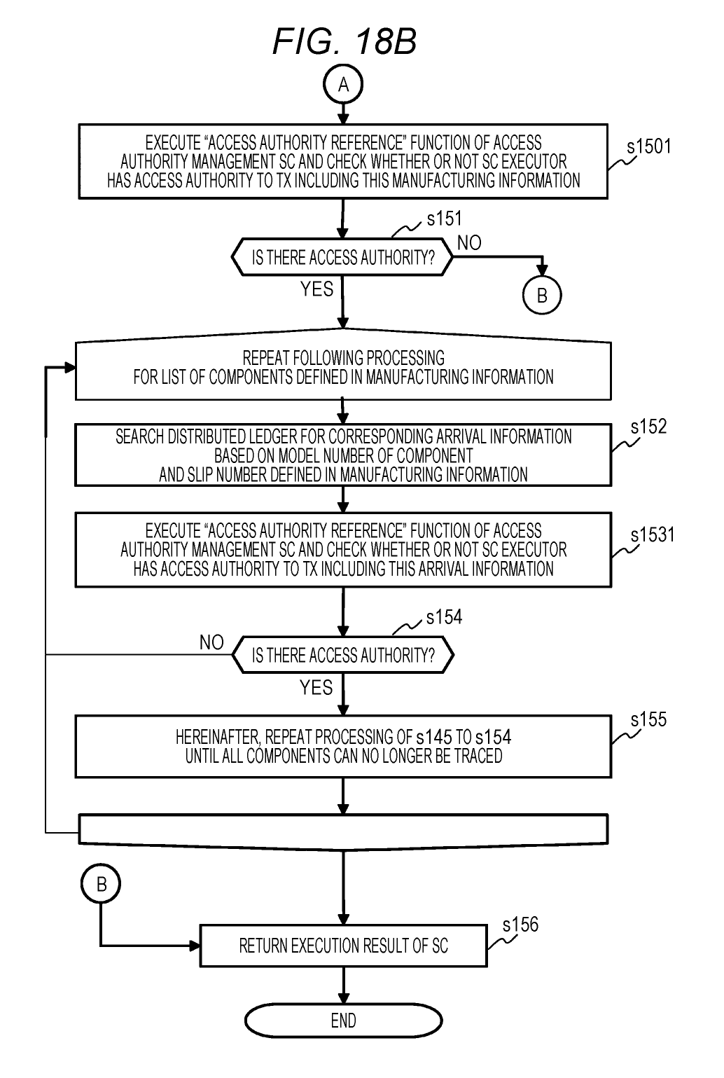

In the component trace SC of the present embodiment, four of “shipment”, “arrival”, “manufacturing”, and “history search” are defined as function names, and logic of each function is defined. Specifically, “logic X” (FIGS. 17A and 17B) is defined for “shipment”, “arrival”, and “manufacturing”, while “logic Y” (FIGS. 18A and 18B) is defined for “history search”.

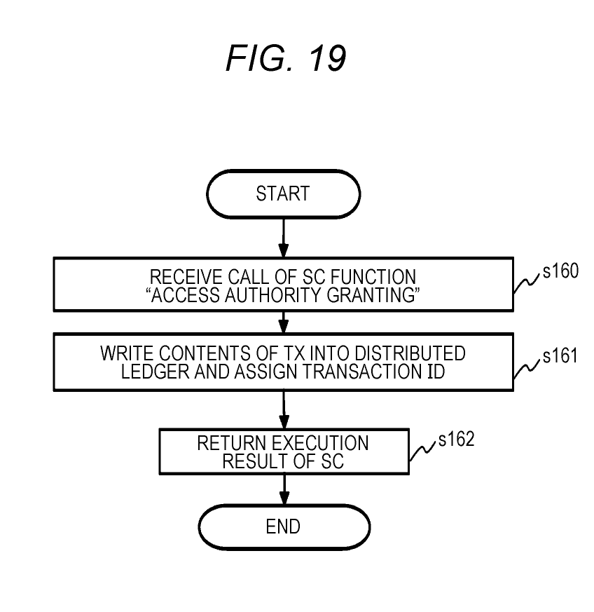

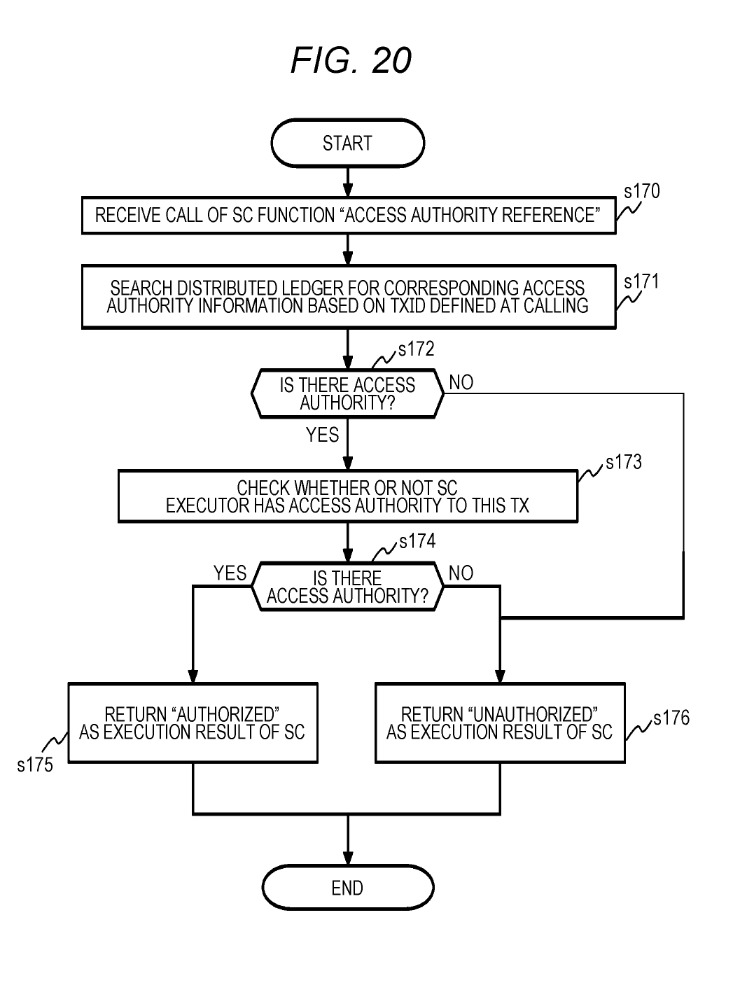

The block 2702 is an example of a block storing the deployment TX of the access authority management SC. In the access authority management SC of the present embodiment, two of “access authority granting” and “access authority reference” are defined as function names, and logic of each function is defined. Specifically, “logic V” (FIG. 19) is defined for “access authority granting”, while “logic W” (FIG. 20) is defined for “access authority reference”.

The blocks 2704 and 2706 are examples of a block storing an execution TX of the access authority management SC. Similarly to the first embodiment, an execution TX 2740 of this embodiment includes a contract ID of the smart contract as a calling object, and information on a function name and an argument to be inputted, of the smart contract as a calling object.

FIG. 16 shows an example of the state information 280 managed on the distributed ledger 250 in the second embodiment. In this embodiment, also for an access authority management contract, a data area in the state information 280 is prepared.

In this case, the state information 280 includes a contract ID 2801 that is an identifier of the smart contract, an entity 2802 of this smart contract, and an internal table 2803 to hold an execution result of the SC. Every time a TX is executed, contents of this internal table 2803 are updated. Access authority data 28060 held by the access authority management SC in the internal table 2803 is equivalent to contents of the access authority management table 330 of the member management node 300 shown in FIG. 7 in the first embodiment.

Next, a flow example of the access authority management method in the second embodiment will be described. FIGS. 17A and 17B are flowcharts showing an example of an internal process at a time of calling “shipment”, “arrival”, and “manufacturing” that are TX writing functions among functions of the component trace SC shown in FIGS. 15A and 15B.

In this embodiment, when granting access authority to the TX to the SC executor in s1221, s1251, s1281, and s1301 in this flow, an SC execution/management unit 220 executes the “access authority granting” function of the access authority management SC instead of calling the member management unit 310 of the member management node 300. Other parts are equivalent to contents of the processing shown in FIGS. 10A and 10B in the first embodiment.

FIGS. 18A and 18B are flowcharts showing an example of an internal process at a time of calling “history search” that is a TX reading function among the functions of the component trace SC shown in FIGS. 15A and 15B.

In the present embodiment, when referring to access authority to the TX by the SC executor in s1431, s1461, s1501, and s1531, the SC execution/management unit 220 executes the “access authority reference” function of the access authority management SC instead of calling the member management unit 310 of the member management node 300. Other parts are equivalent to contents of the processing shown in FIGS. 11A and 11B in the first embodiment.

FIG. 19 is a flowchart showing an example of an internal process at a time of calling “access authority granting” that is the TX writing function described above among the functions of the access authority management SC shown in FIGS. 15A and 15B.

Upon receiving a call of the access authority management SC function “access authority granting” (s160) as the TX formed with consensus, the SC execution/management unit 220 executes a process defined in the SC. A specific internal process is shown below.

First, the SC execution/management unit 220 updates the state information 280 related to this smart contract based on the content of the TX. In this case, the internal table 2803 of the state information 280 stores the access authority data 28060 as shown in FIG. 16, and the SC execution/management unit 220 adds the SC executor's ID in a row corresponding to the ID of the specified TX.

Next, the SC execution/management unit 220 adds the execution TX as the last block of the blockchain 270 (s161). At this time, the SC execution/management unit 220 registers a hash value of a preceding block, a hash value generated from the state information 280, and a transaction ID together.

Finally, the SC execution/management unit 220 returns an execution result (e.g., success) of this SC (s162), and ends the processing.

FIG. 20 is a flowchart showing an example of an internal process at a time of calling “access authority reference” that is the TX writing function described above among the functions of the access authority management SC shown in FIGS. 15A and 15B.

In this case, upon receiving a call of the access authority management SC function “access authority reference” as the TX formed with consensus (s170), the SC execution/management unit 220 executes a process defined in the SC. A specific internal process is shown below.

First, the SC execution/management unit 220 searches the distributed ledger 250 for corresponding access authority information based on a TX ID of an access authority reference object defined in the execution TX (s171).

As a result of this search, when relevant access authority information does not exist in the distributed ledger 250 (s172: NO), the SC execution/management unit 220 advances the processing to s176.

On the other hand, as a result of the above search, when relevant access authority information exists in the distributed ledger 250 (s172: YES), the SC execution/management unit 220 refers to the acquired record and checks whether or not the SC executor has access authority to this TX (s173).

As a result of the above checking, when there is access authority to the TX (s174: YES), the SC execution/management unit 220 returns “authorized” as an execution result of this SC (s175), and ends the processing. Whereas, as a result of the above checking, when there is no access authority to the TX (s174: NO), the SC execution/management unit 220 returns “unauthorized” as an execution result of this SC (s176), and ends the processing.

As described above, adopting the configuration described in the second embodiment can provide the same effect as in the first embodiment. In the present embodiment, the component trace SC and the access authority management SC are defined as separate SCs, but they may be defined as an integrated SC.

Although the best modes and the like for carrying out the present invention have been concretely described above, the present invention is not limited thereto and various modifications can be made without departing from the gist of the present invention.

According to these embodiments, access control can be performed such that a participant in a consortium distributed ledger infrastructure can exclusively access data necessary for, for example, managing traceability of its own product.

That is, it is possible to enable appropriate management of authority of data access in a distributed ledger, by a participant in a consortium distributed ledger infrastructure.

By the description of the present specification, at least the following will be clarified. That is, in the access management method of these embodiments, the predetermined node may specify, as a predetermined process related to authority management of the data access, the presence or absence of authority of data access by a node of the participant to the transaction based on an execution result of the smart contract for each of the transactions, and may control data access to a transaction stored in the distributed ledger based on the presence or absence of authority.

According to this, a specific node that manages the participants of the business network can efficiently specify the presence or absence of authority of the data access described above according to definition contents of the smart contract, enabling accurate control of the data access from participating nodes. This enables appropriate management of authority of data access in a distributed ledger, by a participant in a consortium distributed ledger infrastructure.

Further, in the access management method of these embodiments, the predetermined node may specify, as a predetermined process related to authority management of data access, the presence or absence of authority of data access by a node of the participant to the transaction based on an execution result of the smart contract for each of the transactions, issue a transaction including information on the presence or absence of authority and store the transaction in the distributed ledger, and may control data access to a transaction stored in the distributed ledger based on the presence or absence of authority.

According to this, participating nodes of the business network can securely manage the presence or absence of authority of the data access described above according to the definition contents of the smart contract with the distributed ledger, enabling accurate control of data access from the participating nodes. This enables appropriate management of authority of data access in a distributed ledger, by a participant in a consortium distributed ledger infrastructure.

Further, in the access management method of these embodiments, the predetermined node may execute a predetermined smart contract according to a type of operation indicated by contents of the transaction, and may execute a predetermined process related to authority management of data access in a distributed ledger by a predetermined node of a participant in the business network based on an execution result of the smart contract.

According to this, for example, the presence or absence of authority of the data access described above can be efficiently and accurately specified in accordance with the smart contract corresponding to each type of the operation such as shipment, arrival, or manufacturing in a supply chain, enabling suitable control of data access from the participating nodes. This enables appropriate management of authority of data access in a distributed ledger, by a participant in a consortium distributed ledger infrastructure.

Further, in the access management method of these embodiments, the predetermined node may specify, as a predetermined process related to authority management of the data access, for each of a transaction stored in the distributed ledger and other transactions having a predetermined relationship with the transaction in the distributed ledger, the presence or absence of authority of data access by a node of the participant based on an execution result of the smart contract, and may control data access to the corresponding transaction based on the presence or absence of the authority.

According to this, in a transaction stored in the distributed ledger, for example, based on propriety of disclose to other parties that is determined in accordance with each relationship between a buyer and a supplier in a supply chain, that is, based on the presence or absence of authority of data access, data access from participating nodes can be accurately controlled. This enables appropriate management of authority of data access in a distributed ledger, by a participant in a consortium distributed ledger infrastructure.

Although the present disclosure has been described with reference to example embodiments, those skilled in the art will recognize that various changes and modifications may be made in form and detail without departing from the spirit and scope of the claimed subject matter.

What is claimed is:

1. An access authority management method comprising:
by at least one predetermined node in a distributed ledger system constituting a business network by a predetermined business entity,
executing a predetermined smart contract in accordance with contents of a transaction issued along with execution of a predetermined process and stored in a distributed ledger, and executing, based on an execution result of the smart contract, a predetermined process related to authority management of data access in a distributed ledger by a predetermined node of a participant in the business network.

2. The access authority management method according to claim 1, wherein
the predetermined node specifies, as a predetermined process related to authority management of the data access, a presence or absence of authority of data access by a node of the participant to the transaction based on an execution result of the smart contract for each of the transactions, and controls data access to a transaction stored in the distributed ledger based on the presence or absence of the authority.

3. The access authority management method according to claim 1, wherein
the predetermined node specifies, as a predetermined process related to authority management of the data access, a presence or absence of authority of data access by a node of the participant to the transaction based on an execution result of the smart contract for each of the transactions, issues a transaction including information on the presence or absence of the authority and stores the transaction in a distributed ledger, and controls data access to a transaction stored in the distributed ledger based on the presence or absence of the authority.

4. The access authority management method according to claim 1, wherein
the predetermined node executes a predetermined smart contract in accordance with a type of operation indicated by contents of the transaction, and executes, based on an execution result of the smart contract, a predetermined process related to authority management of data access in a distributed ledger by a predetermined node of a participant in the business network.

5. The access authority management method according to claim 1, wherein
the predetermined node specifies, as a predetermined process related to authority management of the data access, for each of a transaction stored in the distributed ledger and another transaction having a predetermined relationship with the transaction in the distributed ledger, a presence or absence of authority of data access by a node of the participant based on an execution result of the smart contract, and controls data access to a corresponding transaction based on the presence or absence of the authority.

6. An access authority management system that is a distributed ledger system constituting a business network by a predetermined business entity, the access authority management system comprising a plurality of information processing apparatuses each comprising:
a storage device configured to store at least a distributed ledger that stores a transaction issued along with execution of a predetermined process; and
a computing device configured to execute a predetermined smart contract in accordance with contents of a transaction stored in the distributed ledger, and execute, based on an execution result of the smart contract, a predetermined process related to authority management of data access in a distributed ledger by a predetermined node of a participant in the business network.

7. An access authority management apparatus that is at least one predetermined node in a distributed ledger system constituting a business network by a predetermined business entity, the access authority management apparatus comprising:
a storage device configured to store at least a distributed ledger that stores a transaction issued along with execution of a predetermined process; and
a computing device configured to execute a predetermined smart contract in accordance with contents of a transaction stored in the distributed ledger, and execute, based on an execution result of the smart contract, a predetermined process related to authority management of data access in a distributed ledger by a predetermined node of a participant in the business network.
